(19) United States
(12) Patent Application Publication
(10) Pub. No.: US 2015/0019694 A1
(43) Pub. Date: Jan. 15, 2015

(54) Method for Screen Sharing, Related Device, and Communications System

(71) Applicant: Huawei Technologies Co., Ltd., Shenzhen (CN)

(72) Inventors: Ke Feng, Hangzhou (CN); Yanmeng Ren, Hangzhou (CN); Rongliang Liu, Hangzhou (CN)

(21) Appl. No.: 14/487,335

(22) Filed: Sep. 16, 2014

Related U.S. Application Data
(63) Continuation of application No. PCT/CN2014/072506, filed on Feb. 25, 2014.

(30) Foreign Application Priority Data
Jun. 17, 2013 (CN) 201310242043.6

(51) Int. Cl. H04L 29/06; H04W 8/24

(52) U.S. Cl. CPC H04L 65/601; H04W 8/24
USPC 709/219

(57) ABSTRACT

A method for screen sharing, a related device, and a communications system are provided. The method for screen sharing includes: initiating, by a first mobile terminal, a screen sharing service; receiving, by the first mobile terminal by using a wireless local area network, a screen sharing service access request that is corresponding to the screen sharing service and from N second mobile terminal(s), where both the first mobile terminal and the N second mobile terminal(s) are located in the wireless local area network, and N is a positive integer; and when the N second mobile terminal(s) are allowed to access the screen sharing service, encoding, by the first mobile terminal, content displayed on a first area in a screen of the first mobile terminal into a first video stream, and sending the first video stream to the N second mobile terminal(s) by using the wireless local area network.

### CROSS-REFERENCE TO RELATED APPLICATIONS

This application is a continuation of International Application No. PCT/CN2014/072506, filed on Feb. 25, 2014, which claims priority to Chinese Patent Application No. 201310242043.6, filed on Jun. 17, 2013, both of which are hereby incorporated by reference in their entireties.

### TECHNICAL FIELD

The present invention relates to the field of communications technologies, and in particular, to a method for screen sharing, a related device, and a communications system.

### BACKGROUND

At present, with rapid development of smart mobile terminals, screens thereof become larger, display resolution of the screens becomes higher, computing and processing capabilities are being enhanced, and storage space is increasing. Therefore, the smart mobile terminals provide more abundant resource storage and application extensions besides meeting basic communication and entertainment requirements of people, where a sharing function and real-time interaction are functions that are used most widely and frequently.

At present, sharing on a smart mobile terminal is social sharing based on a social network platform, where sharing participated by a plurality of users within a small range is not involved, such as establishing a conference system that a plurality of users participate in within a small range to share document information of a current smart mobile device, or inviting a friend to view a group of wonderful pictures together within a small range. In these scenarios, a sharing initiating party only wants to temporarily share some content within a small range, which is not involved on a conventional social network platform.

The following screen sharing scenario exists at present, where two mobile terminals are connected to each other by using a Bluetooth technology, and then one of the mobile terminals encodes content displayed on a screen of the one of the mobile terminals into a video stream and sends the video stream to the other mobile terminal for displaying, thereby achieving an objective of screen sharing. However, screen sharing based on Bluetooth supports only one-on-one screen sharing; moreover, Bluetooth is limited in a transmission speed and flexibility, and cannot support a condition that has a high requirement on fluency and real-time quality, such as an interface animation and a video.

### SUMMARY

Embodiments of the present invention provide a method for screen sharing, a related device, and a communications system to improve supporting of a screen sharing technology for a scenario that has a high requirement on fluency and real-time quality, and enhance flexibility for a mobile terminal to participate in screen sharing, so as to increase the number of participants of screen sharing.

According to a first aspect of the present invention, a method for screen sharing is provided, which may include: initiating, by a first mobile terminal, a screen sharing service; receiving, by the first mobile terminal by using a wireless local area network, a screen sharing service access request that is corresponding to the screen sharing service and from N second mobile terminal(s), where both the first mobile terminal and the N second mobile terminal(s) are located in the wireless local area network, and N is a positive integer; and when the N second mobile terminal(s) are allowed to access the screen sharing service, encoding, by the first mobile terminal, content displayed on a first area in a screen of the first mobile terminal into a first video stream, and sending the first video stream to the N second mobile terminal(s) by using the wireless local area network.

With reference to the first aspect, in a first possible implementation manner, the initiating, by a first mobile terminal, a screen sharing service includes: broadcasting, in the wireless local area network by the first mobile terminal, a screen sharing service enabling message that corresponds to the screen sharing service, where the screen sharing service access request that corresponds to the screen sharing service is sent by the second mobile terminal after receiving the screen sharing service enabling message; or the initiating, by a first mobile terminal, a screen sharing service includes: receiving, by the first mobile terminal, a screen sharing service enabling query request from the N second mobile terminal(s), and broadcasting, in the wireless local area network, a screen sharing service enabling message that corresponds to the screen sharing service, or sending a screen sharing service enabling message used for responding to the screen sharing service enabling query request to the N second mobile terminal(s), where the screen sharing service access request that corresponds to the screen sharing service is sent by the second mobile terminal after receiving the screen sharing service enabling message.

With reference to the first aspect or the first possible implementation manner of the first aspect, in a second possible implementation manner, the method further includes: executing, by the first mobile terminal, the first user operation event when a first user operation event from the second mobile terminal is received by using the wireless local area network, where the first user operation event is a user operation event for a second area in a screen of the second mobile terminal, and the first video stream received by the second mobile terminal is displayed on the second area.

With reference to the second possible implementation manner of the first aspect, in a third possible implementation manner, a transparent layer is covered over the first area of the first mobile terminal; and the first user operation event is a doodle drawing event, where the executing, by the first mobile terminal, the first user operation event when a first user operation event from the second mobile terminal is received by using the wireless local area network includes: displaying, by the first mobile terminal, a doodle drawn by the doodle drawing event on the transparent layer when a doodle drawing event from the second mobile terminal is received by using the wireless local area network.

With reference to the first aspect, the first possible implementation manner of the first aspect, the second possible implementation manner of the first aspect, or the third possible implementation manner of the first aspect, in a fourth possible implementation manner, the method further includes: collecting, by the first mobile terminal, a sound signal played by the first mobile terminal, encoding the collected sound signal into a first audio stream, and interleaving the first audio stream into the first video stream; or decoding, by the first mobile terminal, an audio file to obtain a first audio stream, and interleaving the first audio stream into the first video stream, where the sending the first video stream to the N second mobile terminal(s) by using the wireless local area network includes: sending the first video stream interleaved with the first audio stream to the N second mobile terminal(s) by using the wireless local area network.

With reference to the first aspect, the first possible implementation manner of the first aspect, the second possible implementation manner of the first aspect, the third possible implementation manner of the first aspect, or the fourth possible implementation manner of the first aspect, in a fifth possible implementation manner, a bit rate of the first video stream is constant, or a bit rate of the first video stream corresponds to a value of N, or a bit rate of the first video stream corresponds to a type of the content displayed on the first area.

With reference to the first aspect, the first possible implementation manner of the first aspect, the second possible implementation manner of the first aspect, the third possible implementation manner of the first aspect, the fourth possible implementation manner of the first aspect, or the fifth possible implementation manner of the first aspect, in a sixth possible implementation manner, the method further includes: enabling, by the first mobile terminal, a remote clip service; and when M second mobile terminal(s) of the N second mobile terminal(s) access the remote clip service by using the wireless local area network, when the first mobile terminal monitors that there is an updated clipping object on a system clipboard of the first mobile terminal, sending the clipping object to the M second mobile terminal(s) by using the wireless local area network, so that the M second mobile terminal(s) update system clipboards of the M second mobile terminal(s) with the clipping object received by the M second mobile terminal(s).

With reference to the first aspect, the first possible implementation manner of the first aspect, the second possible implementation manner of the first aspect, the third possible implementation manner of the first aspect, the fourth possible implementation manner of the first aspect, the fifth possible implementation manner of the first aspect, or the sixth possible implementation manner of the first aspect, in a seventh possible implementation manner, the method further includes: sending, by the first mobile terminal, a voice-tagging service enabling indication to K1 second mobile terminal(s) of the N second mobile terminal(s) when a document is displayed on the first area in the screen of the first mobile terminal; and when a voice tag that is recorded by a part of or all second mobile terminals of the K1 second mobile terminal(s) after receiving the voice-tagging service enabling indication is received, storing the voice tag and recording an association relationship between the voice tag and a first document, where the first document is a document that is displayed by the first mobile terminal on the first area in the screen of the first mobile terminal during duration of recording the voice tag; or, sending, by the first mobile terminal, a voice-tagging service enabling indication to K2 second mobile terminal(s) of the N second mobile terminal(s) when a picture is displayed on the first area in the screen of the first mobile terminal; and when a voice tag that is recorded by a part of or all second mobile terminals of the K2 second mobile terminal(s) after receiving the voice-tagging service enabling indication is received, storing the voice tag and recording an association relationship between the voice tag and a first picture, where the first picture is a picture that is displayed by the first mobile terminal on the first area in the screen of the first mobile terminal during duration of recording the voice tag; or, sending, by the first mobile terminal, a voice-tagging service enabling indication to K3 second mobile terminal(s) of the N second mobile terminal(s) when a video is displayed on the first area in the screen of the first mobile terminal; and when a voice tag that is recorded by a part of or all second mobile terminals of the K3 second mobile terminal(s) after receiving the voice-tagging service enabling indication is received, storing the voice tag and recording an association relationship between the voice tag and a first video, where the first video is a video that is displayed by the first mobile terminal on the first area in the screen of the first mobile terminal during duration of recording the voice tag.

With reference to the first aspect, the first possible implementation manner of the first aspect, the second possible implementation manner of the first aspect, the third possible implementation manner of the first aspect, the fourth possible implementation manner of the first aspect, the fifth possible implementation manner of the first aspect, the sixth possible implementation manner of the first aspect, or the seventh possible implementation manner of the first aspect, in an eighth possible implementation manner, the first mobile terminal is used as a wireless fidelity (WiFi) hotspot, and the N second mobile terminal(s) access the wireless local area network by using the WiFi hotspot; or one second mobile terminal of the N second mobile terminal(s) is used as a WiFi hotspot, and the first mobile terminal and remaining second mobile terminals of the N second mobile terminal(s) except the one second mobile terminal access the wireless local area network by using the WiFi hotspot; or the first mobile terminal is used as a group owner, and the N second mobile terminal(s) are used as group clients and access the wireless local area network in a WiFi Direct mode; or one second mobile terminal of the N second mobile terminal(s) is used as a group owner, and the first mobile terminal and remaining second mobile terminals of the N second mobile terminal(s) except the one second mobile terminal are used as group clients and access the wireless local area network in a WiFi Direct mode; or the first mobile terminal and the N second mobile terminal(s) access the wireless local area network by using a third-party WiFi hotspot.

According to a second aspect of the present invention, a mobile terminal is provided, including: a service initiating unit configured to initiate a screen sharing service; and a sharing unit configured to receive, by using a wireless local area network, a screen sharing service access request that is corresponding to the screen sharing service and from N second mobile terminal(s), where both the mobile terminal and the N second mobile terminal(s) are located in the wireless local area network, and N is a positive integer; and when the N second mobile terminal(s) are allowed to access the screen sharing service, encode content displayed on a first area in a screen of the mobile terminal into a first video stream, and send the first video stream to the N second mobile terminal(s) by using the wireless local area network.

With reference to the second aspect, in a first possible implementation manner, the service initiating unit is specifically configured to broadcast, in the wireless local area network, a screen sharing service enabling message that corresponds to the screen sharing service, where the screen sharing service access request that corresponds to the screen sharing service is sent by the second mobile terminal after receiving the screen sharing service enabling message; or, the service initiating unit is specifically configured to receive a screen sharing service enabling query request from the N second mobile terminal(s), and broadcast, in the wireless local area network, a screen sharing service enabling message that corresponds to the screen sharing service, or send a screen sharing service enabling message used for responding to the screen sharing service enabling query request to the N second mobile terminal(s), where the screen sharing service access request that corresponds to the screen sharing service is sent by the second mobile terminal after receiving the screen sharing service enabling message.

With reference to the second aspect or the first possible implementation manner of the second aspect, in a second possible implementation manner, the mobile terminal further includes: an event response unit configured to execute the first user operation event when a first user operation event from the second mobile terminal is received by using the wireless local area network, where the first user operation event is a user operation event for a second area in a screen of the second mobile terminal, and the first video stream received by the second mobile terminal is displayed on the second area.

With reference to the second possible implementation manner of the second aspect, in a third possible implementation manner, a transparent layer is covered over the first area of the event response unit; and the first user operation event is a doodle drawing event, where the event response unit is configured to display a doodle drawn by the doodle drawing event on the transparent layer when a doodle drawing event from the second mobile terminal is received by using the wireless local area network.

With reference to the second aspect, the first possible implementation manner of the second aspect, the second possible implementation manner of the second aspect, or the third possible implementation manner of the second aspect, in a fourth possible implementation manner, the mobile terminal further includes: an audio processing unit configured to collect a sound signal played by the mobile terminal and encode the collected sound signal into a first audio stream, or decode an audio file to obtain a first audio stream, where the sharing unit is specifically configured to: when the N second mobile terminal(s) access, by using the wireless local area network, the screen sharing service enabled by the mobile terminal, encode the content displayed on the first area in the screen of the mobile terminal into the first video stream, interleave the first audio stream into the first video stream, and send the first video stream interleaved with the first audio stream to the N second mobile terminal(s) by using the wireless local area network.

With reference to the second aspect, the first possible implementation manner of the second aspect, the second possible implementation manner of the second aspect, the third possible implementation manner of the second aspect, or the fourth possible implementation manner of the second aspect, in a fifth possible implementation manner, the mobile terminal further includes: a remote clip service unit configured to enable a remote clip service; and when M second mobile terminal(s) of the N second mobile terminal(s) access the remote clip service by using the wireless local area network, when monitoring that there is an updated clipping object on a system clipboard of the mobile terminal, send the clipping object to the M second mobile terminal(s) by using the wireless local area network, so that the M second mobile terminal(s) update system clipboards of the M second mobile terminal(s) with the clipping object received by the M second mobile terminal(s).

With reference to the second aspect, the first possible implementation manner of the second aspect, the second possible implementation manner of the second aspect, the third possible implementation manner of the second aspect, the fourth possible implementation manner of the second aspect, or the fifth possible implementation manner of the second aspect, in a sixth possible implementation manner, the mobile terminal further includes: a voice tagging unit configured to: send, by using the mobile terminal, a voice-tagging service enabling indication to K1 second mobile terminal(s) of the N second mobile terminal(s) when a document is displayed on the first area in the screen of the mobile terminal; and when a voice tag that is recorded by a part of or all second mobile terminals of the K1 second mobile terminal(s) after receiving the voice-tagging service enabling indication is received, store the voice tag and record an association relationship between the voice tag and a first document, where the first document is a document that is displayed by the mobile terminal on the first area in the screen of the mobile terminal during duration of recording the voice tag; or, send, by using the mobile terminal, a voice-tagging service enabling indication to K2 second mobile terminal(s) of the N second mobile terminal(s) when a picture is displayed on the first area in the screen of the mobile terminal; and when a voice tag that is recorded by a part of or all second mobile terminals of the K2 second mobile terminal(s) after receiving the voice-tagging service enabling indication is received, store the voice tag and record an association relationship between the voice tag and a first picture, where the first picture is a picture that is displayed by the mobile terminal on the first area in the screen of the mobile terminal during duration of recording the voice tag; or, send, by using the mobile terminal, a voice-tagging service enabling indication to K3 second mobile terminal(s) of the N second mobile terminal(s) when a video is displayed on the first area in the screen of the mobile terminal; and when a voice tag that is recorded by a part of or all second mobile terminals of the K3 second mobile terminal(s) after receiving the voice-tagging service enabling indication is received, store the voice tag and record an association relationship between the voice tag and a first video, where the first video is a video that is displayed by the mobile terminal on the first area in the screen of the mobile terminal during duration of recording the voice tag.

According to a third aspect of the present invention, a method for screen sharing is provided, including: detecting, by a second mobile terminal, whether a first mobile terminal initiated a screen sharing service; sending a screen sharing service access request that corresponds to the screen sharing service to the first mobile terminal by using a wireless local area network after detecting that the first mobile terminal initiated the screen sharing service, where both the first mobile terminal and the second mobile terminal are located in the wireless local area network; and receiving a first video stream from the first mobile terminal, and displaying the first video stream on a second area in a screen of the second mobile terminal, where the first video stream is obtained by the first mobile terminal by encoding content displayed on a first area in a screen of the first mobile terminal.

With reference to the third aspect, in a first possible implementation manner, the detecting, by a second mobile terminal, whether a first mobile terminal initiated a screen sharing service includes: after receiving, by using the wireless local area network, a screen sharing service enabling message that is corresponding to the screen sharing service and from the first mobile terminal, determining, by the second mobile terminal, that it is detected that the first mobile terminal enabled the screen sharing service; or broadcasting, by the second mobile terminal, a screen sharing service enabling query request in the wireless local area network, or sending a screen sharing service enabling query request to the first mobile terminal by using the wireless local area network; and when a screen sharing service enabling message that is corresponding to the screen sharing service and from the first mobile terminal is received, determining that the first mobile terminal enabled the screen sharing service.

With reference to the third aspect, or the first possible implementation manner of the third aspect, in a second possible implementation manner, after the displaying the first video stream on a second area in a screen of the second mobile terminal, the method further includes: monitoring, by the second mobile terminal, a first user operation event of a user for the second area, and sending the first user operation event to the first mobile terminal by using the wireless local area network when the first user operation event of the user for the second area is detected, so that the first mobile terminal executes the first user operation event.

With reference to the second possible implementation manner of the third aspect, in a third possible implementation manner, a transparent layer is covered over the first area of the first mobile terminal; and the first user operation event is a doodle drawing event, where the sending the first user operation event to the first mobile terminal by using the wireless local area network when the first user operation event of the user for the second area is detected, so that the first mobile terminal executes the first user operation event includes: sending the doodle drawing event to the first mobile terminal by using the wireless local area network when a doodle drawing event of the user for the second area is detected, so that the first mobile terminal displays, on the transparent layer, a doodle drawn by the doodle drawing event.

With reference to the third aspect, the first possible implementation manner of the third aspect, the second possible implementation manner of the third aspect, or the third possible implementation manner of the third aspect, in a fourth possible implementation manner, the method further includes: accessing, by the second mobile terminal, a remote clip service enabled by the first mobile terminal; and when a clipping object from the first mobile terminal is received by using the wireless local area network, updating a system clipboard with the received clipping object, where the clipping object is a clipping object that is updated on a system clipboard of the first mobile terminal.

With reference to the third aspect, the first possible implementation manner of the third aspect, the second possible implementation manner of the third aspect, the third possible implementation manner of the third aspect, or the fourth possible implementation manner of the third aspect, in a fifth possible implementation manner, the method further includes: when a document is displayed on the second area, when a voice-tagging service enabling indication from the first mobile terminal is received, recording a voice tag and sending the recorded voice tag to the first mobile terminal, so that the first mobile terminal stores the voice tag and records an association relationship between the voice tag and a first document, where the first document is a document displayed on the second area during duration of recording the voice tag; or when a picture is displayed on the second area, when a voice-tagging service enabling indication from the first mobile terminal is received, recording a voice tag and sending the recorded voice tag to the first mobile terminal, so that the first mobile terminal stores the voice tag and records an association relationship between the voice tag and a first picture, where the first picture is a picture displayed on the second area during duration of recording the voice tag; or when a video is displayed on the second area, when a voice-tagging service enabling indication from the first mobile terminal is received, recording a voice tag and sending the recorded voice tag to the first mobile terminal, so that the first mobile terminal stores the voice tag and records an association relationship between the voice tag and a first video, where the first video is a video displayed on the second area during duration of recording the voice tag.

According to a fourth aspect of the present invention, a mobile terminal is provided, including: a detecting unit configured to detect whether a first mobile terminal initiated a screen sharing service; an accessing unit configured to send a screen sharing service access request that corresponds to the screen sharing service to the first mobile terminal by using a wireless local area network after detecting that the first mobile terminal initiated the screen sharing service, where both the first mobile terminal and the mobile terminal are located in the wireless local area network; and a sharing unit configured to receive a first video stream from the first mobile terminal, and display the first video stream on a second area in a screen of the mobile terminal, where the first video stream is obtained by the first mobile terminal by encoding content displayed on a first area in a screen of the first mobile terminal.

With reference to the fourth aspect, in a first possible implementation manner, the detecting unit is specifically configured to: after receiving, by using the wireless local area network, a screen sharing service enabling message that is corresponding to the screen sharing service and from the first mobile terminal, determine that the first mobile terminal enabled the screen sharing service; or, broadcast a screen sharing service enabling query request in the wireless local area network, or send a screen sharing service enabling query request to the first mobile terminal by using the wireless local area network; and when a screen sharing service enabling message that is corresponding to the screen sharing service and from the first mobile terminal is received, determine that the first mobile terminal enabled the screen sharing service.

With reference to the fourth aspect or the first possible implementation manner of the fourth aspect, in a second possible implementation manner, after the displaying the first video stream on the second area in the screen of the mobile terminal, a detecting unit is configured to monitor a first user operation event of a user for the second area, and to send the first user operation event to the first mobile terminal by using the wireless local area network when the first user operation event of the user for the second area is detected, so that the first mobile terminal executes the first user operation event.

With reference to the fourth aspect, the first possible implementation manner of the fourth aspect, or the second possible implementation manner of the fourth aspect, in a third possible implementation manner, the mobile terminal further includes: a remote clip service unit configured to access a remote clip service enabled by the first mobile terminal, and when a clipping object from the first mobile terminal is received by using the wireless local area network, update a system clipboard with the received clipping object, where the clipping object is a clipping object that is updated on a system clipboard of the first mobile terminal.

With reference to the fourth aspect, the first possible implementation manner of the fourth aspect, the second possible implementation manner of the fourth aspect, or the third possible implementation manner of the fourth aspect, in a fourth possible implementation manner, the mobile terminal further includes: a voice tagging unit configured to: when a document is displayed on the second area, when a voice-tagging service enabling indication from the first mobile terminal is received, record a voice tag and send the recorded voice tag to the first mobile terminal, so that the first mobile terminal stores the voice tag and records an association relationship between the voice tag and a first document, where the first document is a document displayed on the second area during duration of recording the voice tag; or, when a picture is displayed on the second area, when a voice-tagging service enabling indication from the first mobile terminal is received, record a voice tag and send the recorded voice tag to the first mobile terminal, so that the first mobile terminal stores the voice tag and records an association relationship between the voice tag and a first picture, where the first picture is a picture displayed on the second area during duration of recording the voice tag; or, when a video is displayed on the second area, when a voice-tagging service enabling indication from the first mobile terminal is received, record a voice tag and send the recorded voice tag to the first mobile terminal, so that the first mobile terminal stores the voice tag and records an association relationship between the voice tag and a first video, where the first video is a video displayed on the second area during duration of recording the voice tag.

According to a fifth aspect of the present invention, a communications system is provided, which may include: a first mobile terminal and N second mobile terminal(s), where the first mobile terminal and the N second mobile terminal(s) are located in a same wireless local area network, and N is a positive integer, where the first mobile terminal is configured to initiate a screen sharing service; receive, by using the wireless local area network, a screen sharing service access request that is corresponding to the screen sharing service and from the N second mobile terminal(s); and when the N second mobile terminal(s) are allowed to access the screen sharing service, encode content displayed on a first area in a screen of the first mobile terminal into a first video stream, and send the first video stream to the N second mobile terminal(s) by using the wireless local area network.

It can be seen that, in the embodiments of the present invention, after a first mobile terminal enables a screen sharing service that a plurality of mobile terminals is allowed to access, when N second mobile terminal(s) access, by using a wireless local area network, the screen sharing service enabled by the first mobile terminal, the first mobile terminal encodes content displayed on a first area in a screen of the first mobile terminal into a first video stream, and sends the first video stream to the N second mobile terminal(s) by using the wireless local area network. Because both the first mobile terminal and the N second mobile terminal(s) access the same wireless local area network, the first mobile terminal and the N second mobile terminal(s) perform the screen sharing service based on the wireless local area network, and exchange data related to the screen sharing service. Screen sharing data exchange implemented based on the wireless local area network may address an issue of screen sharing within a small range without a large-scale external server or an external network, and may achieve an effect that is easy-to-use, simple, and practical. Moreover, with a high transmission rate of the wireless local area network, the access is simple and access by a plurality of terminals is supported, so that the screen sharing technology according to the embodiments of the present invention can better support a scenario that has a high requirement on fluency and real-time quality; moreover, the first mobile terminal may implement access control over the screen sharing service of a plurality of N second mobile terminal(s) by using the wireless local area network, which also helps to enhance flexibility for participating in screen sharing, so as to increase the number of participants of screen sharing.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. The accompanying drawings in the following description show merely some embodiments of the present invention, and persons of ordinary skill in the art may still derive other drawings from these accompanying drawings without creative efforts.

FIG. 1 is a schematic flowchart of a method for screen sharing provided by an embodiment of the present invention;

FIG. 2 is a schematic diagram illustrating screen sharing area setting provided by an embodiment of the present invention;

FIG. 3A to FIG. 3E are schematic diagrams illustrating construction of several wireless local area networks provided by an embodiment of the present invention;

FIG. 3F is a schematic diagram of a doodle service provided by an embodiment of the present invention;

FIG. 3G is a schematic flowchart of another method for screen sharing provided by an embodiment of the present invention;

FIG. 4A is a schematic diagram of an architecture of a system for screen sharing provided by an embodiment of the present invention;

FIG. 4B is a schematic diagram of a video stream buffer queue and a blocking buffer queue provided by an embodiment of the present invention;

FIG. 5A to FIG. 5E are schematic diagrams of several mobile terminals provided by an embodiment of the present invention;

FIG. 6A to FIG. 6D are schematic diagrams of several mobile terminals provided by an embodiment of the present invention;

FIG. 7 is a schematic diagram of another mobile terminal provided by an embodiment of the present invention;

FIG. 8 is a schematic diagram of another mobile terminal provided by an embodiment of the present invention;

FIG. 9 is a schematic diagram of a communications system provided by an embodiment of the present invention; and

FIG. 10 is a schematic diagram of another mobile terminal provided by an embodiment of the present invention.

### DETAILED DESCRIPTION

Embodiments of the present invention provide a method for screen sharing, a related device, and a communications system to improve supporting of a screen sharing technology for a scenario that has a high requirement on fluency and real-time quality, and enhance flexibility for a mobile terminal to participate in screen sharing, so as to increase the number of participants of screen sharing.

To make persons skilled in the art better understand the technical solutions in the present invention, the following clearly describes the technical solutions in the embodiments of the present invention with reference to the accompanying drawings in the embodiments of the present invention. The described embodiments are merely a part rather than all of the embodiments of the present invention. All other embodiments obtained by persons of ordinary skill in the art based on the embodiments of the present invention without creative efforts shall fall within the protection scope of the present invention.

Detailed descriptions are provided as follows:

The terms “first”, “second”, “third”, “fourth” and the like (if any) in the specification, claims, and accompanying drawings of the present invention are used to differentiate similar objects, and are not necessarily used to describe a specific sequence or order. It should be understood that data used in this way is interchangeable under proper circumstances, so that the embodiments of the present invention described herein may, for example, be implemented in a sequence except that shown or described herein. In addition, the terms “include”, “have” and any variants of them are intended to mean non-exclusive including. For example, a process, a method, a system, a product, or a device including a series of steps or units does not necessarily need to clearly list all the steps or units, and may also include other steps or units that are not clearly listed or are inherent to these processes, methods, products, or devices.

According to an embodiment of a method for screen sharing according to the present invention, the method for screen sharing may include: initiating, by a first mobile terminal, a screen sharing service; receiving, by the first mobile terminal by using a wireless local area network, a screen sharing service access request that is corresponding to the screen sharing service and from N second mobile terminal(s), where both the first mobile terminal and the N second mobile terminal(s) are located in the wireless local area network, and N is a positive integer; and when the N second mobile terminal(s) are allowed to access the screen sharing service, encoding, by the first mobile terminal, content displayed on a first area in a screen of the first mobile terminal into a first video stream, and sending the first video stream to the N second mobile terminal(s) by using the wireless local area network.

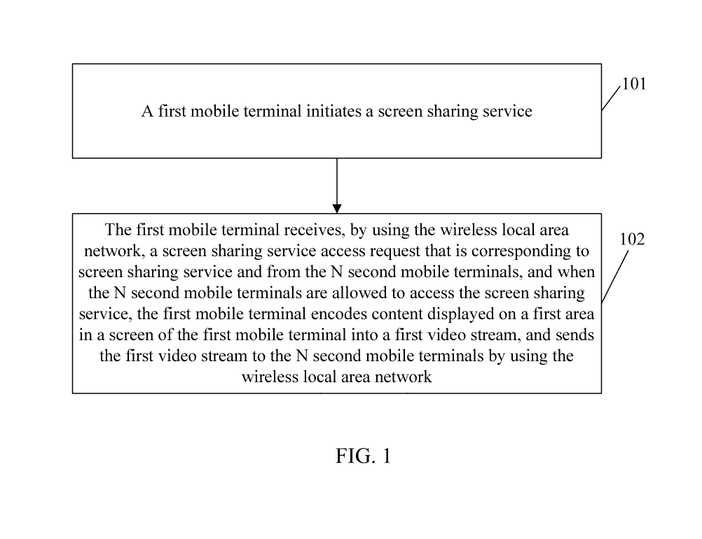

Refer to FIG. 1, where FIG. 1 is a schematic flowchart of a method for screen sharing provided by an embodiment of the present invention. As shown in FIG. 1, the method for screen sharing provided by the embodiment of the present invention may include the following content:

101. A first mobile terminal initiates a screen sharing service.

A mobile terminal in the embodiments of the present invention may be a smart mobile terminal, a portable computer, a personal digital assistant, or the like. Certainly, the mobile terminal in the embodiments of the present invention may have a touch display screen or a screen of another type.

It may be understood that, the first mobile terminal (a screen sharing client is installed on the first mobile terminal) initiates the screen sharing service, which represents that the first mobile terminal allows another mobile terminal to share a screen with the first mobile terminal, and some mobile terminals (for example, a mobile terminal on which a screen sharing client is installed) within the same local area network may detect that the first mobile terminal enabled the screen sharing service, and may access the screen sharing service enabled by the first mobile terminal. The mobile terminal initiating the screen sharing service may be referred to as a screen sharing service initiating party, and the mobile terminal accessing the screen sharing service may be referred to as a screen sharing service accessing party.

102. The first mobile terminal receives, by using the wireless local area network, a screen sharing service access request that is corresponding to screen sharing service and from the N second mobile terminal(s), and when the N second mobile terminal(s) are allowed to access the screen sharing service, the first mobile terminal encodes content displayed on a first area in a screen of the first mobile terminal into a first video stream, and sends the first video stream to the N second mobile terminal(s) by using the wireless local area network. Both the first mobile terminal and the N second mobile terminal(s) are located in the wireless local area network, and N is a positive integer. Therefore, after receiving the first video stream sent by the first mobile terminal, the second mobile terminal may display the first video stream (that is, display content corresponding to the first video stream) on an area (which is referred to as a second area for ease of citation) of a screen of the second mobile terminal; correspondingly, the second mobile terminal may display the first video stream on the second area of the screen of the second mobile terminal after receiving the first video stream sent by the first mobile terminal.

In some embodiments of the present invention, the initiating, by a first mobile terminal, a screen sharing service may include: broadcasting, in the wireless local area network by the first mobile terminal, a screen sharing service enabling message that corresponds to the screen sharing service, where the screen sharing service access request that corresponds to the screen sharing service is sent by the second mobile terminal after receiving the screen sharing service enabling message.

In addition, in some other embodiments of the present invention, the initiating, by a first mobile terminal, a screen sharing service may include: receiving, by the first mobile terminal, a screen sharing service enabling query request from the N second mobile terminal(s), and broadcasting, in the wireless local area network, a screen sharing service enabling message that corresponds to the screen sharing service, or sending a screen sharing service enabling message used for responding to the screen sharing service enabling query request to the N second mobile terminal(s), where the screen sharing service access request that corresponds to the screen sharing service is sent by the second mobile terminal after receiving the screen sharing service enabling message.

In some embodiments of the present invention, the first mobile terminal may determine, according to a user instruction, a remaining processing resource, or signal quality of the wireless local area network, whether to allow the N second mobile terminal(s) to access the screen sharing service.

It may be understood that, after receiving the screen sharing service access request from the second mobile terminal, the first mobile terminal may send a screen sharing service reject access message to the second mobile terminal (or does not reply with any messages) when the second mobile terminal is not allowed to access the screen sharing service, and may send a screen sharing service allow access message to the second mobile terminal when the second mobile terminal is allowed to access the screen sharing service.

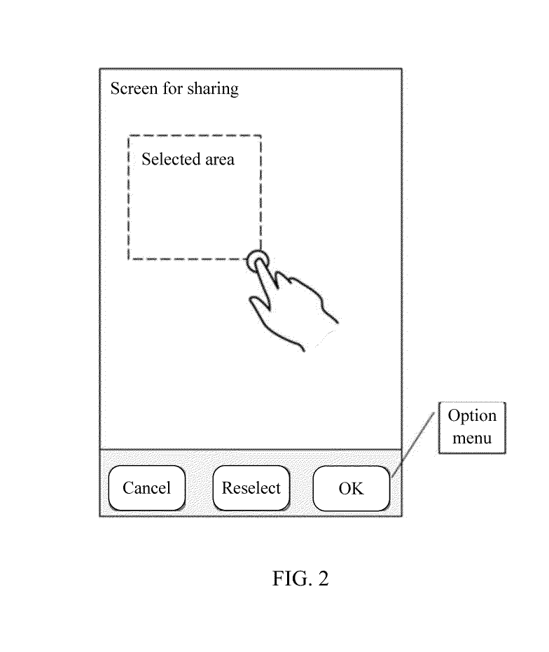

The first mobile terminal may select an area (which is referred to as a first area for ease of citation) in the screen of the first mobile terminal as a screen sharing area. The first area selected by the first mobile terminal for screen sharing may cover a part of or all the screen of the first mobile terminal. FIG. 2 uses an example in which the first area covers a part of the screen of the first mobile terminal. The first mobile terminal may display content, such as a picture, a video, a document, or the desktop, on the first area.

The following describes, by using an example, a manner in which the first mobile terminal selects the screen sharing area, as shown in FIG. 2. After a user triggers an operation of selecting a sharing area, the first mobile terminal covers a semi-transparent layer over a current screen; the user may slide with a finger on the semi-transparent layer; in a sliding process of the finger, a rectangular block is generated by using an initial touch point of the finger as a vertex and a current touch point in the sliding process of the finger as a diagonal vertex, where the rectangular block is re-drawn and changes constantly as the finger slides. When the finger leaves the screen and stops sliding, the first mobile terminal records position and size parameters of the currently selected area, and an option menu bar may pop up at the same time, where the option menu bar is displayed at the bottom; and the user selects one required option from the option menu to complete current setting of a screen sharing area. For example, the option menu has three options, namely, “cancel”, “reselect”, and “OK”. Selecting “cancel” means to discard the current setting, where the first mobile terminal may cancel displaying of the option menu, cancel displaying of the rectangular block of the selected area, cancel displaying of the semi-transparent layer, and exit a setting mode; selecting “reselect” represents that a sharing area needs to be set again, where the rectangular block of the selected area and the option menu bar disappear on the first mobile terminal, and the user may perform a setting step again; and after “OK” is selected, the first mobile terminal cancels displaying of the option menu, cancels the displaying of the rectangular block of the selected area, and cancels the displaying of the semi-transparent layer.

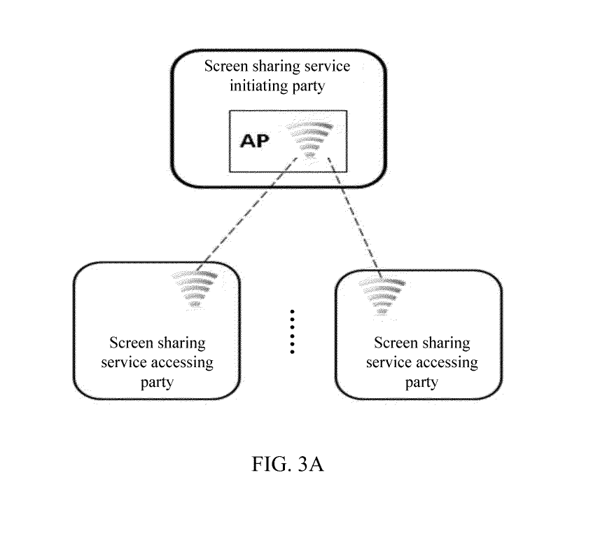

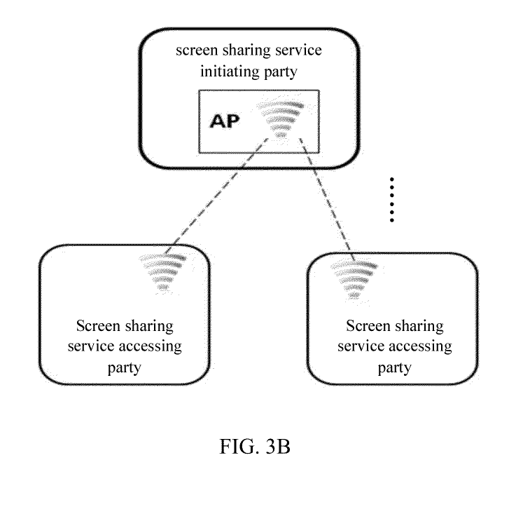

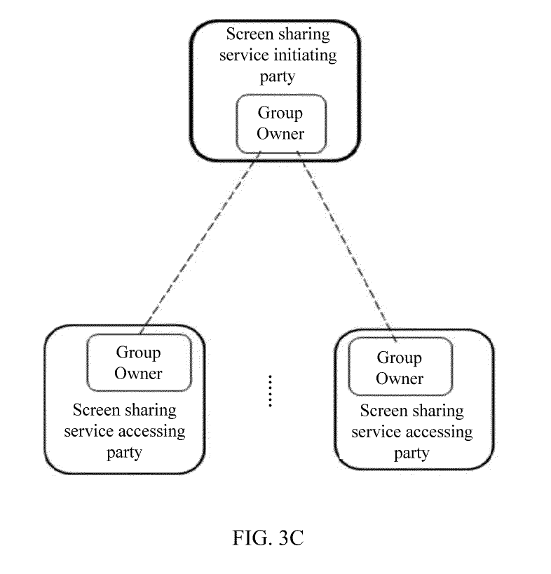

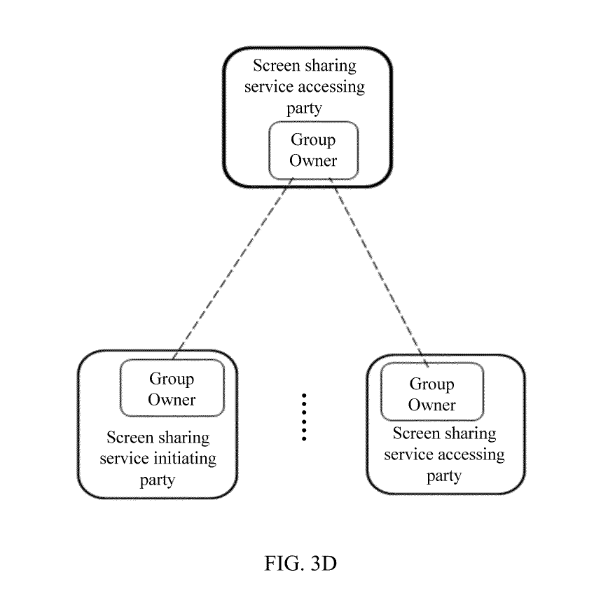

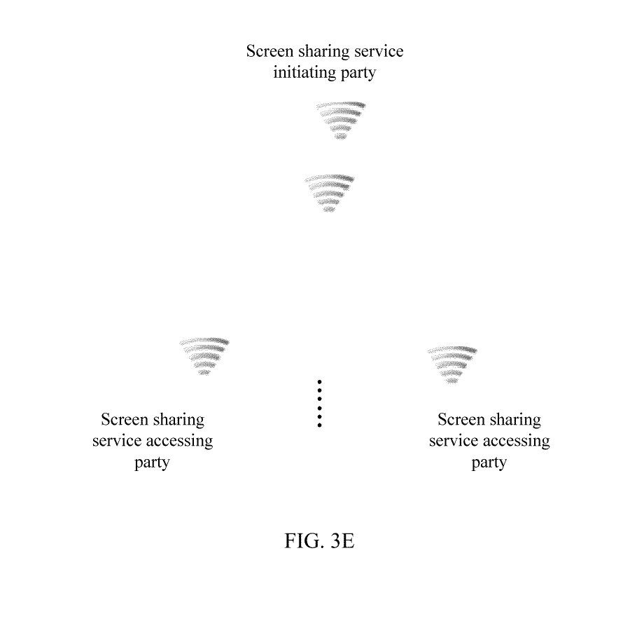

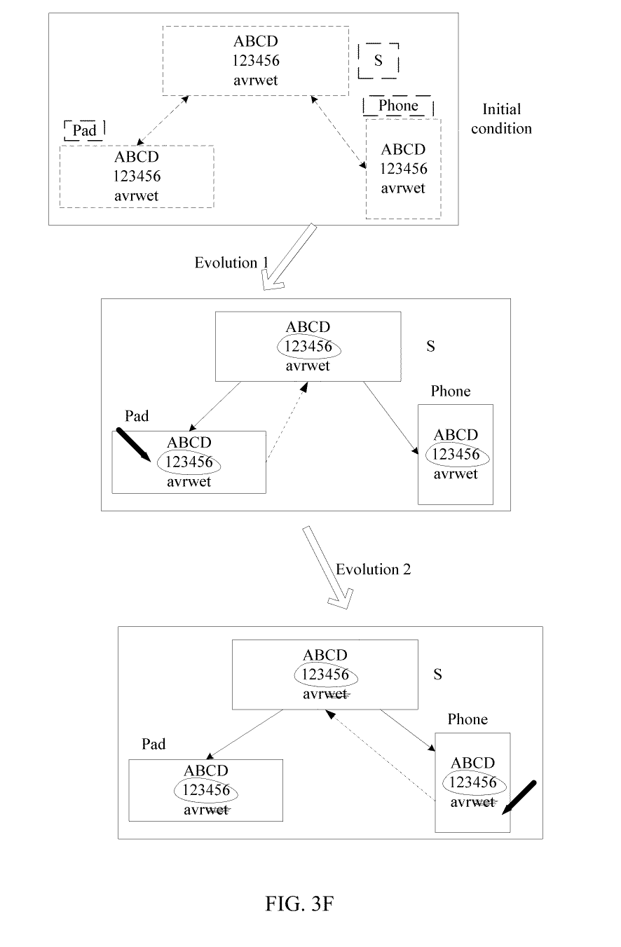

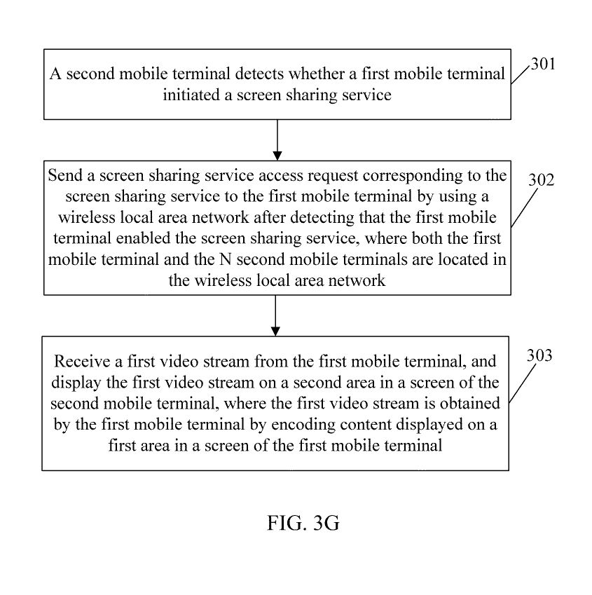

In some embodiments of the present invention, the first mobile terminal is used as a WiFi hotspot, and the N second mobile terminal(s) access the wireless local area network by using the WiFi hotspot (refer to FIG. 3A). Alternatively, one second mobile terminal of the N second mobile terminal(s) is used as a WiFi hotspot, and the first mobile terminal and remaining second mobile terminals of the N second mobile terminal(s) except the one second mobile terminal access the wireless local area network by using the WiFi hotspot (refer to FIG. 3B). Alternatively, the first mobile terminal is used as a group owner, and the N second mobile terminal(s) are used as group clients and access the wireless local area network in a WiFi Direct mode (refer to FIG. 3C). Alternatively, one second mobile terminal of the N second mobile terminal(s) is used as a group owner, and the first mobile terminal and remaining second mobile terminals of the N second mobile terminal(s) except the one second mobile terminal are used as group clients and access the wireless local area network in a WiFi Direct mode (refer to FIG. 3D). Alternatively, the first mobile terminal and the N second mobile terminal(s) access the wireless local area network by using a third-party WiFi hotspot (refer to FIG. 3E). Certainly, the first mobile terminal and the N second mobile terminal(s) may also access the same wireless local area network in another manner.

In some embodiments of the present invention, the first mobile terminal may send the first video stream to the N second mobile terminal(s) based on a multicast or unicast manner by using the wireless local area network. For example, the first mobile terminal may include a video stream buffer queue and a blocking buffer queue; for the unicast manner, the first mobile terminal may put video frames of the first video stream into the video stream buffer queue one by one according to a first-in-first-out principle, where when a first video frame stored by an X^{th} queue unit in the video stream buffer queue is to be replaced with a second video frame in the first video stream, when the first video frame still is not successfully sent to K4 second mobile terminals of the N second mobile terminal(s) (that is, the K4 second mobile terminals failed to obtain the first video frame), the first video frame is written into a queue unit that is in the blocking buffer queue and corresponding to the K4 second mobile terminals (where at least one queue unit in the blocking buffer queue corresponds to each second mobile terminal of the N second mobile terminal(s)), and then the first video frame stored by the X^{th} queue unit is replaced with the second video frame. The sending the first video stream to the N second mobile terminal(s) by using the wireless local area network may include: for each second mobile terminal of the N second mobile terminal(s), sending a video frame, which is read from the video stream buffer queue and/or blocking buffer queue, in the first video stream to each second mobile terminal. It can be seen that the video stream buffer queue and the blocking buffer queue that are used in cooperation are introduced into the mobile terminal initiating the screen sharing service, which helps to save a memory overhead in a scenario in which a plurality of mobile terminals accesses the screen sharing service; because the first mobile terminal does not need to store a video frame, which is released unsuccessfully, in the video stream buffer queue for long, an outputting speed of the video stream buffer queue may be the same as an encoding speed which is used to obtain the first video stream, and moreover, at least one queue unit in the blocking buffer queue corresponds to each second mobile terminal of the N second mobile terminal(s), which helps to implement that video streams do not affect each other, thereby achieving a technical effect of saving a memory overhead and a time overhead without affecting the video streams.

In some embodiments of the present invention, when a first user operation event from the second mobile terminal is received by using the wireless local area network, the first mobile terminal executes the first user operation event, where the first user operation event is a user operation event for a second area in a screen of the second mobile terminal, and the first video stream received by the second mobile terminal is displayed on the second area. The first mobile terminal may add the first user operation event into a system operation event linked list, and execute the first user operation event according to an execution sequence of events in the system operation event linked list. The first user operation event may be a plurality of user operation events for the second area in the screen of the second mobile terminal. Assuming that an animation is displayed on the second area, the first user operation event may be, for example, a user operation event used for adjusting a speed, brightness, contrast, and/or a size of the animation displayed on the second area. Assuming that a desktop including a plurality of application icons is displayed on the second area, the first user operation event may be, for example, a user operation event used for starting an application corresponding to an application icon in the desktop displayed on the second area, and a user operation event of another function may be similar. If necessary, the second mobile terminal may convert the detected user operation event for the second area in the screen of the second mobile terminal into a first user operation event of a specified format (for example, the first mobile terminal specified a format of user operation events), and send the first user operation event to the first mobile terminal by using the wireless local area network, so that the first mobile terminal executes the first user operation event. Certainly, if the first mobile terminal and the second mobile terminal are of the same system type, and the first mobile terminal can identify the user operation event detected by the second mobile terminal, the second mobile terminal may send the detected user operation event to the first mobile terminal without performing format conversion.

In some embodiments of the present invention, screen sharing may further support a doodle function. For example, a transparent layer may be covered over the first area of the first mobile terminal, and the first user operation event is a doodle drawing event, where the executing, by the first mobile terminal, the first user operation event when the first user operation event from the second mobile terminal is received by using the wireless local area network includes: displaying, by the first mobile terminal, a doodle drawn by the doodle drawing event on the transparent layer when a doodle drawing event from the second mobile terminal is received by using the wireless local area network, where the drawn doodle may also be shared with other screen sharing service accessing parties. For example, as shown in FIG. 3F, a screen sharing service initiating party S shares content on a screen sharing area with screen sharing service accessing parties, a Pad and a Phone; firstly, the Pad makes a doodle mark on the sharing area; in this case, the doodle mark made by the Pad may be seen on all three devices. Then, the Phone also makes some doodle marks on the sharing area, and the doodle marks made by the Phone may also be seen on all three devices; other scenarios are similar.

In some embodiments of the present invention, the first mobile terminal may further collect a sound signal played by the first mobile terminal, encode the collected sound signal into a first audio stream, and interleave the first audio stream into the first video stream; or the first mobile terminal decodes an audio file to obtain a first audio stream, and interleaves the first audio stream into the first video stream, where the sending the first video stream to the N second mobile terminal(s) by using the wireless local area network may include: sending the first video stream interleaved with the first audio stream to the N second mobile terminal(s) by using the wireless local area network. In this case, the first mobile terminal may release a voice instruction, play background music, and the like to the second mobile terminal on this basis.

In some embodiments of the present invention, the first mobile terminal interleaves the first audio stream and the first video stream into a video stream of a HyperText Transfer Protocol live streaming (HLS) format; the first mobile terminal may also interleave the first audio stream and the first video stream into a video stream of a non-HLS format, for example, the first mobile terminal may interleave the first audio stream and the first video stream into a video stream of a format specified by the second mobile terminal. A part of or all second mobile terminals of the N second mobile terminal(s) may access the video stream of the HLS format by using a browser, and a part of or all second mobile terminals of the N second mobile terminal(s) may access the video stream of the non-HLS format by using a dedicated client.

In some embodiments of the present invention, a bit rate of the first video stream may be constant. Alternatively, a bit rate of the first video stream may correspond to a value of N. For example, when the number of mobile terminals accessing the screen sharing service changes, the first mobile terminal may dynamically adjust a bit rate of the video stream. For example, when detecting that the number of mobile terminals accessing the screen sharing service changes, the first mobile terminal may adjust the bit rate of the video stream according to the changed number of mobile terminals accessing the screen sharing service. Assuming that a bit rate of a video stream is A when only one mobile terminal accesses the screen sharing service, but the current number of mobile terminals accessing the screen sharing service is N, a current bit rate of the video stream may be A/N. That is, the larger number of mobile terminals accessing the screen sharing service causes a lower bit rate of the video stream. Alternatively, the bit rate of the first video stream may correspond to a type of the content displayed on the first area. For example, when a type of content currently displayed by the first mobile terminal on the first area is a high-dynamic image (such as a video and an interface animation), the first mobile terminal may increase a frame rate of the first video stream and reduce a frame size of the first video stream, so as to improve fluency of the first video stream; when the type of the content currently displayed by the first mobile terminal on the first area is not a high-dynamic image, the first mobile terminal may reduce the frame rate of the video stream and improve the frame size of the video stream, so as to improve resolution of the first video stream.

It may be understood that the first mobile terminal may determine, according to whether a mobile terminal accesses the screen sharing service, whether to start encoding the first video stream. For example, when no mobile terminal accesses the screen sharing service, encoding of the first video stream is not started; when at least one mobile terminal accesses the screen sharing service, encoding of the first video stream is started; and when all mobile terminals accessing the screen sharing service disconnect, the first mobile terminal may stop encoding the first video stream. Certainly, the first mobile terminal may also keep encoding the first video stream during duration of initiating the screen sharing service.

In some embodiments of the present invention, the first mobile terminal may further start a remote clip service, and when M second mobile terminal(s) of the N second mobile terminal(s) access the remote clip service by using the wireless local area network, when the first mobile terminal monitors that there is an updated clipping object on a system clipboard of the first mobile terminal, send the clipping object to the M second mobile terminal(s) by using the wireless local area network, so that the M second mobile terminal(s) update system clipboards of the M second mobile terminal(s) with the clipping object received by the M second mobile terminal(s).

In some embodiments of the present invention, voice tagging may be further implemented when screen sharing is performed. For example, the first mobile terminal may further send a voice-tagging service enabling indication to K1 second mobile terminal(s) of the N second mobile terminal(s) when a document is displayed on the first area in the screen of the first mobile terminal; and when a voice tag that is recorded by a part of or all second mobile terminals of the K1 second mobile terminal(s) after receiving the voice-tagging service enabling indication is received, store the voice tag and record an association relationship between the voice tag and a first document, where the first document is a document that is displayed by the first mobile terminal on the first area in the screen of the first mobile terminal during duration of recording the voice tag. Further, when opening the first document again, the first mobile terminal may play the voice tag that has the association relationship with the first document. It may be understood that K1 is less than or equal to N.

For another example, the first mobile terminal sends a voice-tagging service enabling indication to K2 second mobile terminal(s) of the N second mobile terminal(s) when a picture is displayed on the first area in the screen of the first mobile terminal; and when a voice tag that is recorded by a part of or all second mobile terminals of the K2 second mobile terminal(s) after receiving the voice-tagging service enabling indication is received, stores the voice tag and records an association relationship between the voice tag and a first picture, where the first picture is a picture that is displayed by the first mobile terminal on the first area in the screen of the first mobile terminal during duration of recording the voice tag. Further, when opening the first picture again, the first mobile terminal may play the voice tag that has the association relationship with the first picture.

It may be understood that K2 is less than or equal to N.

For another example, the first mobile terminal sends a voice-tagging service enabling indication to K3 second mobile terminal(s) of the N second mobile terminal(s) when a video is displayed on the first area in the screen of the first mobile terminal; and when a voice tag that is recorded by a part of or all second mobile terminals of the K3 second mobile terminal(s) after receiving the voice-tagging service enabling indication is received, stores the voice tag and records an association relationship between the voice tag and a first video, where the first video is a video that is displayed by the first mobile terminal on the first area in the screen of the first mobile terminal during duration of recording the voice tag. Voice tagging may be performed in another scenario according to a similar manner. Further, when opening the first video again, the first mobile terminal may play the voice tag that has the association relationship with the first video. It may be understood that K3 is less than or equal to N.

It may be seen that, in this embodiment, after a first mobile terminal enables a screen sharing service that a plurality of mobile terminals is allowed to access, when N second mobile terminal(s) access, by using the wireless local area network, the screen sharing service enabled by the first mobile terminal, the first mobile terminal encodes content displayed on a first area in a screen of the first mobile terminal into a first video stream, and sends the first video stream to the N second mobile terminal(s) by using the wireless local area network. Because both the first mobile terminal and the N second mobile terminal(s) access the same wireless local area network, the first mobile terminal and the N second mobile terminal(s) perform the screen sharing service based on the wireless local area network, and exchange data related to the screen sharing service. Screen sharing data exchange implemented based on the wireless local area network may address an issue of screen sharing within a small range without a large-scale external server or an external network, and may achieve an effect that is easy-to-use, simple, and practical. Moreover, with a high transmission rate of the wireless local area network, the access is simple and access by a plurality of terminals is supported, so that the screen sharing technology according to the embodiments of the present invention can better support a scenario that has a high requirement on fluency and real-time quality; moreover, the first mobile terminal may implement access control over the screen sharing service of a plurality of N second mobile terminal(s) by using the wireless local area network, which also helps to enhance flexibility for participating in screen sharing, so as to increase the number of participants of screen sharing.

Further, a different encoding method may be used according to a difference in a type of content currently displayed on the screen, which helps to solve a problem of balancing a fluency requirement in a scenario that requires high fluency, such as a video or an interface animation, and a resolution requirement in a scenario of displaying a picture, thereby helping to achieve an effect that an encoded video stream dynamically responds to a scenario requirement when a scenario displayed on the screen is switched.

Further, a video stream buffer queue and a blocking buffer queue that are used in cooperation are introduced into the mobile terminal initiating the screen sharing service, which helps to save a memory overhead in a scenario in which a plurality of mobile terminals accesses the screen sharing service, and implement that video streams do not affect each other, thereby achieving a technical effect of saving a memory overhead and a time overhead without affecting the video streams.

Refer to FIG. 3G, where FIG. 3G is a schematic flowchart of a method for screen sharing provided by another embodiment of the present invention. As shown in FIG. 3G, the method for screen sharing provided by the another embodiment of the present invention may include the following content:

301. A second mobile terminal detects whether a first mobile terminal initiated a screen sharing service.

302. Send a screen sharing service access request that corresponds to the screen sharing service to the first mobile terminal by using a wireless local area network after detecting that the first mobile terminal initiated the screen sharing service, where both the first mobile terminal and the second mobile terminal are located in the wireless local area network.

303. Receive a first video stream from the first mobile terminal, and display the first video stream on a second area in a screen of the second mobile terminal, where the first video stream is obtained by the first mobile terminal by encoding content displayed on a first area in a screen of the first mobile terminal.

The second mobile terminal may detect, in a plurality of manners, whether the first mobile terminal initiated the screen sharing service. For example, the detecting, by a second mobile terminal, whether a first mobile terminal initiated a screen sharing service may include: after receiving, by using the wireless local area network, a screen sharing service enabling message that is corresponding to the screen sharing service and from the first mobile terminal, determining, by the second mobile terminal, that the first mobile terminal enabled the screen sharing service; or broadcasting, by the second mobile terminal, a screen sharing service enabling query request in the wireless local area network, or sending a screen sharing service enabling query request to the first mobile terminal by using the wireless local area network; and when the screen sharing service enabling message that is corresponding to the screen sharing service and from the first mobile terminal is received, determining that the first mobile terminal enabled the screen sharing service.

In some embodiments of the present invention, after the displaying the first video stream on the second area in the screen of the second mobile terminal, the method further includes: monitoring, by the second mobile terminal, a first user operation event of a user for the second area, and sending the first user operation event to the first mobile terminal by using the wireless local area network when the first user operation event of the user for the second area is detected, so that the first mobile terminal executes the first user operation event.

In some embodiments of the present invention, the first mobile terminal may be used as a WiFi hotspot, and the second mobile terminal accesses the wireless local area network by using the WiFi hotspot; or the second mobile terminal is used as a WiFi hotspot, and the first mobile terminal accesses the wireless local area network by using the WiFi hotspot; or the first mobile terminal is used as a group owner, and the second mobile terminal accesses the wireless local area network as a group client in a WiFi Direct mode; or the second mobile terminal is used as a group owner, and the first mobile terminal accesses the wireless local area network as a group client in a WiFi Direct mode; or the first mobile terminal and the second mobile terminal accesses the wireless local area network by using a third-party WiFi hotspot.

In some embodiments of the present invention, a transparent layer is covered over the first area of the first mobile terminal, and the first user operation event is a doodle drawing event, where the sending the first user operation event to the first mobile terminal by using the wireless local area network when the first user operation event of the user for the second area is detected, so that the first mobile terminal executes the first user operation event includes: sending the doodle drawing event to the first mobile terminal by using the wireless local area network when a doodle drawing event of the user for the second area is detected, so that the first mobile terminal displays, on the transparent layer, a doodle drawn by the doodle drawing event.

In some embodiments of the present invention, the second mobile terminal may further access a remote clip service enabled by the first mobile terminal; and when a clipping object from the first mobile terminal is received by using the wireless local area network, update a system clipboard with the received clipping object, where the clipping object is a clipping object that is updated on a system clipboard of the first mobile terminal.

In some embodiments of the present invention, the method further includes: when a document is displayed on the second area, when a voice-tagging service enabling indication from the first mobile terminal is received, recording a voice tag and sending the recorded voice tag to the first mobile terminal, so that the first mobile terminal stores the voice tag and records an association relationship between the voice tag and a first document, where the first document is a document displayed on the second area during duration of recording the voice tag; and/or when a picture is displayed on the second area, when a voice-tagging service enabling indication from the first mobile terminal is received, recording a voice tag and sending the recorded voice tag to the first mobile terminal, so that the first mobile terminal stores the voice tag and records an association relationship between the voice tag and a first picture, where the first picture is a picture displayed on the second area during duration of recording the voice tag; and/or when a video is displayed on the second area, when a voice-tagging service enabling indication from the first mobile terminal is received, recording a voice tag and sending the recorded voice tag to the first mobile terminal, so that the first mobile terminal stores the voice tag and records an association relationship between the voice tag and a first video, where the first video is a video displayed on the second area during duration of recording the voice tag.

It may be understood that, the embodiments shown in FIG. 1 and FIG. 3G are described by using the first mobile terminal as a screen sharing service initiating party and the second mobile terminal as the screen sharing service accessing party; certainly, the same mobile terminal may be used as a screen sharing service initiating party at a moment, and be used as a screen sharing service accessing party at the same moment or at another moment. Therefore, the first mobile terminal may have a part of or all functions of the second mobile terminal that are described in the foregoing embodiments.

For better understanding and implementation of the forgoing technical solution according to the embodiment of the present invention, the following uses several application scenarios as an example for description.

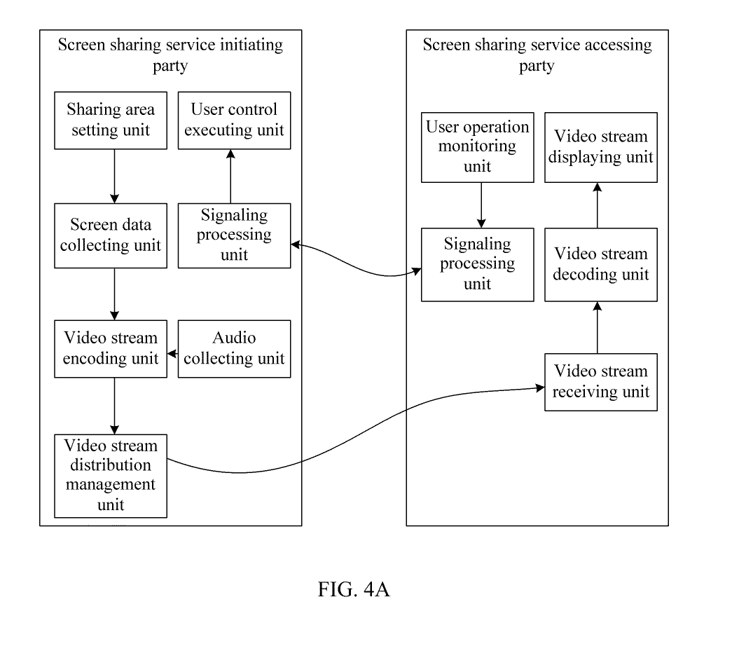

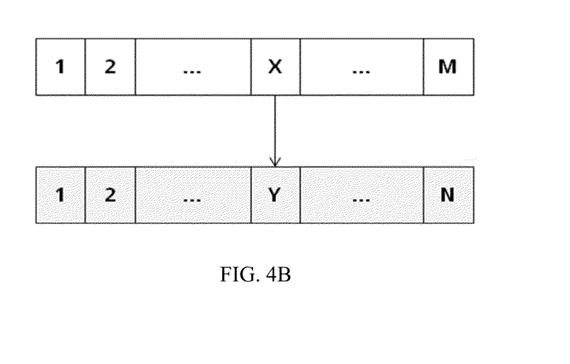

Refer to FIG. 4A, where FIG. 4A is a schematic diagram of a system for screen analysis provided by an embodiment of the present invention.

As shown in FIG. 4A, a first mobile terminal as a screen sharing service initiating party may include a sharing area setting unit, a screen data collecting unit, an audio collecting unit, a video stream encoding unit, a video stream distribution management unit, a user control executing unit, and a signaling processing unit.

A second mobile terminal as a screen sharing service accessing party may include a user operation monitoring unit, a signaling processing unit, a video stream displaying unit, a video stream decoding unit, and a video stream receiving unit.

The foregoing units of the first mobile terminal and the second mobile terminal may cooperate to complete several main functions of the solution according to the present invention, for example, encoding content displayed by a sharing screen into a video stream, and then sharing the video stream with each screen sharing service accessing party to display; transferring, by the screen sharing service accessing party, a detected user operation event to the screen sharing service initiating party; and executing, by the screen sharing service initiating party, the received user operation event from the screen sharing service accessing party.

The following describes a video stream processing manner involved in a screen sharing process by using an example.

The sharing area setting unit of the screen sharing service initiating party receives an instruction of the user for setting a screen sharing area, and transfers a screen sharing area setting parameter to the screen data collecting unit. The screen data collecting unit collects, according to the screen sharing area setting parameter, displayed content of a corresponding area, and sends the collected displayed content to the video stream encoding unit. The audio collecting unit may, after collecting an audio currently played by a device, send the audio to the video stream encoding unit. The video stream encoding unit of the screen sharing service initiating party encodes the received displayed content into a first video stream, and sends the first video stream to the video stream distribution management unit. The video stream distribution management unit may send the first video stream to each screen sharing service accessing party.

The video stream receiving unit of the screen sharing service accessing party receives the first video stream from the screen sharing service initiating party, and transfers the first video stream to the video stream decoding unit. The video stream decoding unit sends the received first video stream to the video stream displaying unit after performing decoding. The video stream displaying unit displays the received decoded first video stream.

The following describes a user operation controlling manner of the screen sharing service accessing party by using an example.

After a user operation event is detected, the user operation monitoring unit of the screen sharing service accessing party transfers the detected user operation event to the signaling processing unit; the signaling processing unit of the screen sharing service accessing party sends the user operation event to the screen sharing service initiating party. After receiving the user operation event from the screen sharing service accessing party, the signaling processing unit of the screen sharing service initiating party converts the received user operation event into a user operation event that can be executed by a system of the screen sharing service accessing party (where an operation of converting the user operation event may also be executed by the signaling processing unit of the screen sharing service accessing party), and sends the user operation event to the user control executing unit of the screen sharing service accessing party; the user control executing unit may add the received user operation event into a system operation event list, and execute the user operation event based on the system operation event list.

The following describes a manner in which the screen sharing service initiating party selects a screen sharing area, as shown in FIG. 2. After a user triggers an operation of selecting a sharing area, the sharing area setting unit covers a semi-transparent layer over a current screen; the user may slide with a finger on the semi-transparent layer; in a sliding process of the finger, a rectangular block is generated by using an initial touch point of the finger as a vertex and a current touch point in the sliding process of the finger as a diagonal vertex, where the rectangular block is re-drawn and changes constantly as the finger slides. When the finger leaves the screen and stops sliding, the sharing area setting unit records position and size parameters of the currently selected area, and an option menu bar may pop up at the same time, where the option menu bar is displayed at the bottom; and the user selects one required option from the option menu to complete current setting of a screen sharing area. For example, the option menu has three options, namely, “cancel”, “reselect”, and “OK”. Selecting “cancel” means to discard the current setting, where the sharing area setting unit may cancel displaying of the option menu, cancel displaying of the rectangular block of the selected area, cancel displaying of the semi-transparent layer, and exit a setting mode; selecting “reselect” represents that a sharing area needs to be set again, where the sharing area setting unit cancels the rectangular block of the selected area and the option menu bar, and the user may perform a setting step again; and after “OK” is selected, the sharing area setting unit may cancel displaying of the option menu, cancel the displaying of the rectangular block of the selected area, and cancel the displaying of the semi-transparent layer.

In some embodiments of the present invention, the screen data collecting unit may copy the content displayed on the screen of the screen sharing service initiating party to a data buffer area of the screen data collecting unit. The screen data collecting unit cuts the screen sharing area from the whole screen according to margins of the screen sharing area, and sends the obtained displayed content to the video stream encoding unit for encoding into the first video stream.

In some embodiments of the present invention, the video stream encoding unit may retain a bit rate of the first video stream constant. Alternatively, a bit rate of the first video stream may correspond to a value of N. For example, when the number of mobile terminals accessing the screen sharing service changes, the video stream encoding unit may dynamically adjust a bit rate of the video stream. For example, when detecting that the number of mobile terminals accessing the screen sharing service changes, the video stream encoding unit may adjust the bit rate of the video stream according to the changed number of mobile terminals accessing the screen sharing service. Assuming that a bit rate of a video stream is A when only one mobile terminal accesses the screen sharing service, but the current number of mobile terminals accessing the screen sharing service is N, a current bit rate of the video stream may be A/N. That is, the larger number of mobile terminals accessing the screen sharing service causes a lower bit rate of the video stream. Alternatively, the bit rate of the first video stream may correspond to a type of the content displayed on the first area. For example, when a type of content currently displayed by the first mobile terminal on the first area is a high-dynamic image (such as a video and an interface animation), the video stream encoding unit may increase a frame rate of the first video stream and reduce a frame size of the first video stream, so as to improve fluency of the first video stream; when the type of the content currently displayed by the first mobile terminal on the first area is not a high-dynamic image, the video stream encoding unit may reduce the frame rate of the video stream and improve the frame size of the video stream, so as to improve resolution of the first video stream.

It may be understood that the video stream encoding unit may determine, according to whether a mobile terminal accesses the screen sharing service, whether to start encoding the first video stream. For example, when no mobile terminal accesses the screen sharing service, encoding of the first video stream is not started; when at least one mobile terminal accesses the screen sharing service, encoding of the first video stream is started; and when all mobile terminals accessing the screen sharing service disconnect, the video stream encoding unit may stop encoding the first video stream. Certainly, the video stream encoding unit may also keep encoding the first video stream during duration of initiating the screen sharing service.

In some embodiments of the present invention, the video stream encoding unit interleaves the first audio stream and the first video stream into a video stream of an HLS format; the video stream encoding unit may also interleave the first audio stream and the first video stream into a video stream of a non-HLS format, for example, the video stream encoding unit may interleave the first audio stream and the first video stream into a video stream of a format specified by the second mobile terminal. A part of or all second mobile terminals of the N second mobile terminal(s) may access the video stream of the HLS format by using a browser, or a part of or all second mobile terminals of the N second mobile terminal(s) may access the video stream of the non-HLS format by using a dedicated client.

In some embodiments of the present invention, the video stream distribution management unit may, for example, send the first video stream to the N second mobile terminal(s), which access the screen sharing service, based on a multicast or unicast manner by using the wireless local area network. For example, the first mobile terminal may include a video stream buffer queue and a blocking buffer queue; for the unicast manner, the video stream distribution management unit may put video frames of the first video stream into the video stream buffer queue one by one according to a first-in-first-out principle; when the video stream buffer queue is full, a new video frame replaces an old video frame at the beginning of the queue. When a first video frame stored by an X^{th} queue unit in the video stream buffer queue is to be replaced with a second video frame in the first video stream, when the first video frame still is not successfully sent to K4 second mobile terminals of the N second mobile terminal(s) (that is, the K4 second mobile terminals failed to obtain the first video frame, where in FIG. 4B, it is assumed that K4 equals 1, a blocking buffer queue in FIG. 4B includes N queue units, and a video stream buffer queue includes M queue units), the first video frame is written into a queue unit that is in the blocking buffer queue and corresponding to the K4 second mobile terminals (where at least one queue unit in the blocking buffer queue corresponds to each second mobile terminal of the N second mobile terminal(s)), and then the first video frame stored by the X^{th} queue unit is replaced with the second video frame. The sending the first video stream to the N second mobile terminal(s) by using the wireless local area network may include: for each second mobile terminal of the N second mobile terminal(s), sending a video frame, which is read from the video stream buffer queue and/or blocking buffer queue, in the first video stream to each second mobile terminal. It can be seen that the video stream buffer queue and the blocking buffer queue that are used in cooperation are introduced into the mobile terminal initiating the screen sharing service, which helps to save a memory overhead in a scenario in which a plurality of mobile terminals accesses the screen sharing service; because the first mobile terminal does not need to store a video frame, which is released unsuccessfully, in the video stream buffer queue for long, an outputting speed of the video stream buffer queue may be the same as an encoding speed which is used to obtain the first video stream, and moreover, at least one queue unit in the blocking buffer queue corresponds to each second mobile terminal of the N second mobile terminal(s), which helps to implement that video streams do not affect each other, thereby achieving a technical effect of saving a memory overhead and a time overhead without affecting the video streams.

In some embodiments of the present invention, a voice tagging service unit of the screen sharing service initiating party may enable a voice tagging service. For example, the signaling processing unit may further send a voice-tagging service enabling indication to K1 second mobile terminal(s) of the N second mobile terminal(s) when a document is displayed on the first area in the screen of the first mobile terminal. An audio recording unit of the second mobile terminal records a voice tag after receiving the voice-tagging service enabling indication, and the audio recording unit of the second mobile terminal may send the recorded voice tag to the screen sharing service initiating party. When the voice tag that is recorded by a part of or all second mobile terminals of the K1 second mobile terminal(s) after receiving the voice-tagging service enabling indication is received, the voice tagging service unit of the screen sharing service initiating party stores the voice tag and records an association relationship between the voice tag and a first document, where the first document is a document that is displayed by the first mobile terminal on the first area in the screen of the first mobile terminal during duration of recording the voice tag. Further, when opening the first document again, the first mobile terminal may play the voice tag that has the association relationship with the first document. It may be understood that K1 is less than or equal to N.

For another example, the voice tagging service unit sends a voice-tagging service enabling indication to K2 second mobile terminal(s) of the N second mobile terminal(s) when a picture is displayed on the first area in the screen of the first mobile terminal; and when a voice tag that is recorded by a part of or all second mobile terminals of the K2 second mobile terminal(s) after receiving the voice-tagging service enabling indication is received, stores the voice tag and records an association relationship between the voice tag and a first picture, where the first picture is a picture that is displayed by the first mobile terminal on the first area in the screen of the first mobile terminal during duration of recording the voice tag. Further, when opening the first picture again, the first mobile terminal may play the voice tag that has the association relationship with the first picture.

It may be understood that K2 is less than or equal to N.

For another example, the voice tagging service unit sends a voice-tagging service enabling indication to K3 second mobile terminal(s) of the N second mobile terminal(s) when a video is displayed on the first area in the screen of the first mobile terminal; and when a voice tag that is recorded by a part of or all second mobile terminals of the K3 second mobile terminal(s) after receiving the voice-tagging service enabling indication is received, stores the voice tag and records an association relationship between the voice tag and a first video, where the first video is a video that is displayed by the first mobile terminal on the first area in the screen of the first mobile terminal during duration of recording the voice tag. Voice tagging may be performed in another scenario according to a similar manner. Further, when opening the first video again, the first mobile terminal may play the voice tag that has the association relationship with the first video. It may be understood that K3 is less than or equal to N.

It may be understood that the screen sharing service initiating party and the screen sharing service accessing party may also have another module composition form, which is not limited to an example shown in FIG. 4A.

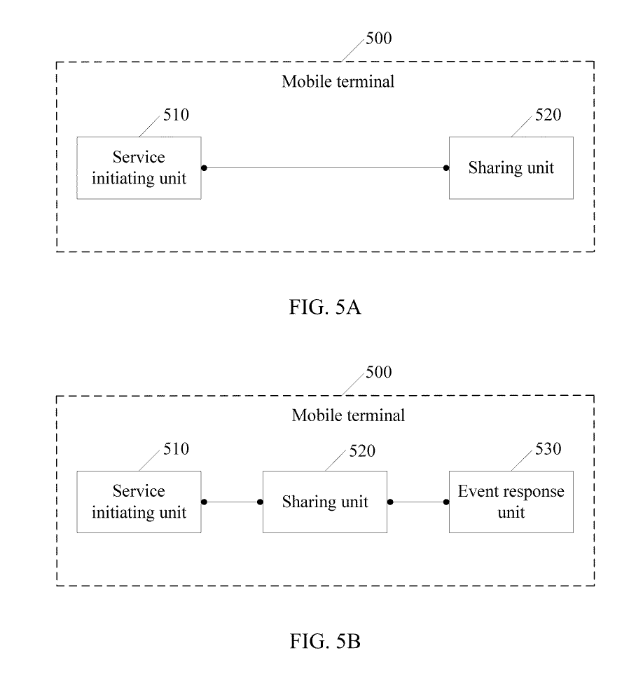

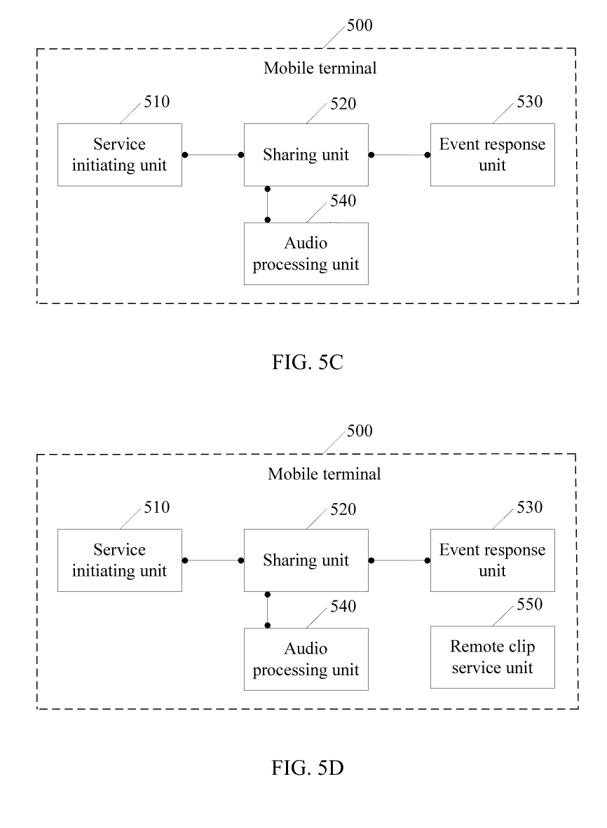

Refer to FIG. 5A, an embodiment of the present invention further provides a mobile terminal 500, which may include a service initiating unit 510 and a sharing unit 520.

The service initiating unit 510 is configured to initiate a screen sharing service.

The sharing unit 520 is configured to receive, by using a wireless local area network, a screen sharing service access request that is corresponding to the screen sharing service and from N second mobile terminal(s), where both the mobile terminal and the N second mobile terminal(s) are located in the wireless local area network, and N is a positive integer; and when the N second mobile terminal(s) are allowed to access the screen sharing service, encode content displayed on a first area in a screen of the mobile terminal into a first video stream, and send the first video stream to the N second mobile terminal(s) by using the wireless local area network.

In some embodiments of the present invention, the service initiating unit 510 may be specifically configured to broadcast, in the wireless local area network, a screen sharing service enabling message that corresponds to the screen sharing service, where the screen sharing service access request that corresponds to the screen sharing service is sent by the second mobile terminal after receiving the screen sharing service enabling message; or, the service initiating unit 510 may be specifically configured to receive a screen sharing service enabling query request from the N second mobile terminal(s), and broadcast, in the wireless local area network, a screen sharing service enabling message that corresponds to the screen sharing service, or send a screen sharing service enabling message used for responding to the screen sharing service enabling query request to the N second mobile terminal(s), where the screen sharing service access request that corresponds to the screen sharing service is sent by the second mobile terminal after receiving the screen sharing service enabling message.

Refer to FIG. 5B, in some embodiments of the present invention, the mobile terminal 500 may further include an event response unit 530 configured to execute the first user operation event when a first user operation event from the second mobile terminal is received by using the wireless local area network, where the first user operation event is a user operation event for a second area in a screen of the second mobile terminal, and the first video stream received by the second mobile terminal is displayed on the second area.

In some embodiments of the present invention, a transparent layer is covered over the first area of the event response unit 530, and the first user operation event is a doodle drawing event, where the event response unit 530 is configured to display a doodle drawn by the doodle drawing event on the transparent layer when a doodle drawing event from the second mobile terminal is received by using the wireless local area network.

Refer to FIG. 5C, in some embodiments of the present invention, the mobile terminal 500 further includes: an audio processing unit 540 configured to collect a sound signal played by the first mobile terminal and encode the collected sound signal into a first audio stream, or decode an audio file to obtain a first audio stream, where the sharing unit 520 may be specifically configured to: when the N second mobile terminal(s) access, by using the wireless local area network, the screen sharing service enabled by the first mobile terminal, encode the content displayed on the first area in the screen of the first mobile terminal into the first video stream, interleave the first audio stream into the first video stream, and send the first video stream interleaved with the first audio stream to the N second mobile terminal(s) by using the wireless local area network.

In some embodiments of the present invention, a bit rate of the first video stream is constant, or a bit rate of the first video stream corresponds to a value of N, or a bit rate of the first video stream corresponds to a type of the content displayed on the first area.

Refer to FIG. 5D, in some embodiments of the present invention, the mobile terminal 500 further includes: a remote clip service unit 550 configured to enable a remote clip service; and when M second mobile terminal(s) of the N second mobile terminal(s) access the remote clip service by using the wireless local area network, when monitoring that there is an updated clipping object on a system clipboard of the first mobile terminal has, send the clipping object to the M second mobile terminal(s) by using the wireless local area network, so that the M second mobile terminal(s) update system clipboards of the M second mobile terminal(s) with the clipping object received by the M second mobile terminal(s).

Refer to FIG. 5E, in some embodiments of the present invention, the mobile terminal 500 further includes: a voice tagging unit 560 configured to: send, by using the mobile terminal 500, a voice-tagging service enabling indication to K1 second mobile terminal(s) of the N second mobile terminal(s) when the mobile terminal 500 displays a document on the first area in the screen of the mobile terminal; and when a voice tag that is recorded by a part of or all second mobile terminals of the K1 second mobile terminal(s) after receiving the voice-tagging service enabling indication is received, store the voice tag and record an association relationship between the voice tag and a first document, where the first document is a document that is displayed by the mobile terminal 500 on the first area in the screen of the mobile terminal during duration of recording the voice tag; and/or, send, by using the mobile terminal 500, a voice-tagging service enabling indication to K2 second mobile terminal(s) of the N second mobile terminal(s) when a picture is displayed on the first area in the screen of the mobile terminal 500; and when a voice tag that is recorded by a part of or all second mobile terminals of the K2 second mobile terminal(s) after receiving the voice-tagging service enabling indication is received, store the voice tag and record an association relationship between the voice tag and a first picture, where the first picture is a picture that is displayed by the mobile terminal 500 on the first area in the screen of the mobile terminal during duration of recording the voice tag; and/or, send, by using the mobile terminal 500, a voice-tagging service enabling indication to K3 second mobile terminal(s) of the N second mobile terminal(s) when a video is displayed on the first area in the screen of the mobile terminal 500; and when a voice tag that is recorded by a part of or all second mobile terminals of the K3 second mobile terminal(s) after receiving the voice-tagging service enabling indication is received, store the voice tag and record an association relationship between the voice tag and a first video, where the first video is a video that is displayed by the mobile terminal 500 on the first area in the screen of the mobile terminal during duration of recording the voice tag.

In some embodiments of the present invention, the mobile terminal 500 is used as a WiFi hotspot, and the N second mobile terminal(s) access the wireless local area network by using the WiFi hotspot (refer to FIG. 3A). Alternatively, one second mobile terminal of the N second mobile terminal(s) is used as a WiFi hotspot, and the mobile terminal 500 and remaining second mobile terminals of the N second mobile terminal(s) except the one second mobile terminal access the wireless local area network by using the WiFi hotspot (refer to FIG. 3B). Alternatively, the mobile terminal 500 is used as a group owner, and the N second mobile terminal(s) are used as group clients and access the wireless local area network in a WiFi Direct mode (refer to FIG. 3C). Alternatively, the mobile terminal 500 and the N second mobile terminal(s) access the wireless local area network by using a third-party WiFi hotspot (refer to FIG. 3D). Certainly, the mobile terminal 500 and the N second mobile terminal(s) may also access the same wireless local area network in another manner.

In some embodiments of the present invention, the sharing unit 520 may send the first video stream to the N second mobile terminal(s) based on a multicast or unicast manner by using the wireless local area network. For example, the mobile terminal 500 may include a video stream buffer queue and a blocking buffer queue; for the unicast manner, the sharing unit 520 may put video frames of the first video stream into the video stream buffer queue one by one according to a first-in-first-out principle, where when a first video frame stored by an X^{th} queue unit in the video stream buffer queue is to be replaced with a second video frame in the first video stream, when the first video frame still is not successfully sent to K4 second mobile terminals of the N second mobile terminal(s) (that is, the K4 second mobile terminals failed to obtain the first video frame), the first video frame is written into a queue unit that is in the blocking buffer queue and corresponding to the K4 second mobile terminals (where at least one queue unit in the blocking buffer queue corresponds to each second mobile terminal of the N second mobile terminal(s)), and then the first video frame stored by the X^{th} queue unit is replaced with the second video frame. The sending the first video stream to the N second mobile terminal(s) by using the wireless local area network may include: for each second mobile terminal of the N second mobile terminal(s), sending a video frame, which is read from the video stream buffer queue and/or blocking buffer queue, in the first video stream to each second mobile terminal. It can be seen that the video stream buffer queue and the blocking buffer queue that are used in cooperation are introduced into the mobile terminal initiating the screen sharing service, which helps to save a memory overhead in a scenario in which a plurality of mobile terminals accesses the screen sharing service; because the mobile terminal 500 does not need to store a video frame, which is released unsuccessfully, in the video stream buffer queue for long, an outputting speed of the video stream buffer queue may be the same as an encoding speed which is used to obtain the first video stream, and moreover, at least one queue unit in the blocking buffer queue corresponds to each second mobile terminal of the N second mobile terminal(s), which helps to implement that video streams do not affect each other, thereby achieving a technical effect of saving a memory overhead and a time overhead without affecting the video streams.

It may be seen that, in this embodiment, after a mobile terminal 500 enables a screen sharing service that a plurality of mobile terminals is allowed to access, when N second mobile terminal(s) access, by using a wireless local area network, the screen sharing service enabled by the mobile terminal 500, the mobile terminal 500 encodes content displayed on a first area in a screen of the mobile terminal 500 into a first video stream, and sends the first video stream to the N second mobile terminal(s) by using the wireless local area network. Because both the mobile terminal 500 and the N second mobile terminal(s) access the same wireless local area network, the mobile terminal 500 and the N second mobile terminal(s) perform the screen sharing service based on the wireless local area network, and exchange data related to the screen sharing service. Screen sharing data exchange implemented based on the wireless local area network may address an issue of screen sharing within a small range without a large-scale external server or an external network, and may achieve an effect that is easy-to-use, simple, and practical. Moreover, with a high transmission rate of the wireless local area network, the access is simple and access by a plurality of terminals is supported, so that the screen sharing technology according to the embodiments of the present invention can better support a scenario that has a high requirement on fluency and real-time quality, which also helps to enhance flexibility for participating in screen sharing, so as to increase the number of participants of screen sharing.

Further, a different encoding method may be used according to a difference in a type of content currently displayed on the screen, which helps to solve a problem of balancing a fluency requirement in a scenario that requires high fluency, such as a video or an interface animation, and a resolution requirement in a scenario of displaying a picture, thereby helping to achieve an effect that an encoded video stream dynamically responds to a scenario requirement when a scenario displayed on the screen is switched.

Further, a video stream buffer queue and a blocking buffer queue that are used in cooperation are introduced into the mobile terminal initiating the screen sharing service, which helps to save a memory overhead in a scenario in which a plurality of mobile terminals accesses the screen sharing service, and implement that video streams do not affect each other, thereby achieving a technical effect of saving a memory overhead and a time overhead without affecting the video streams.

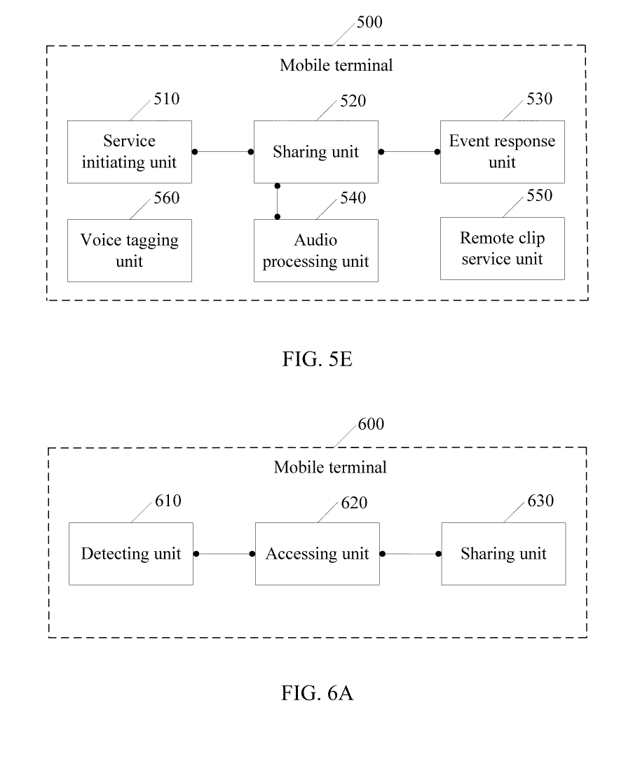

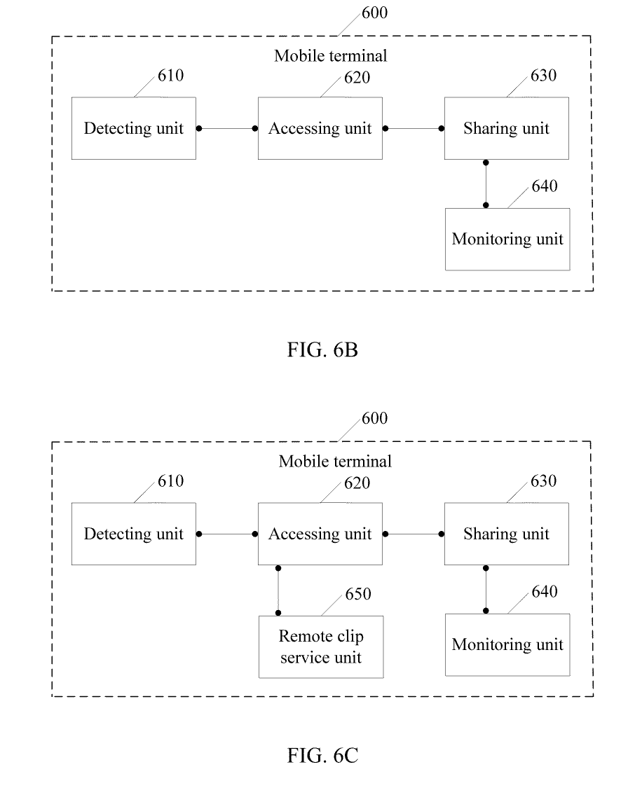

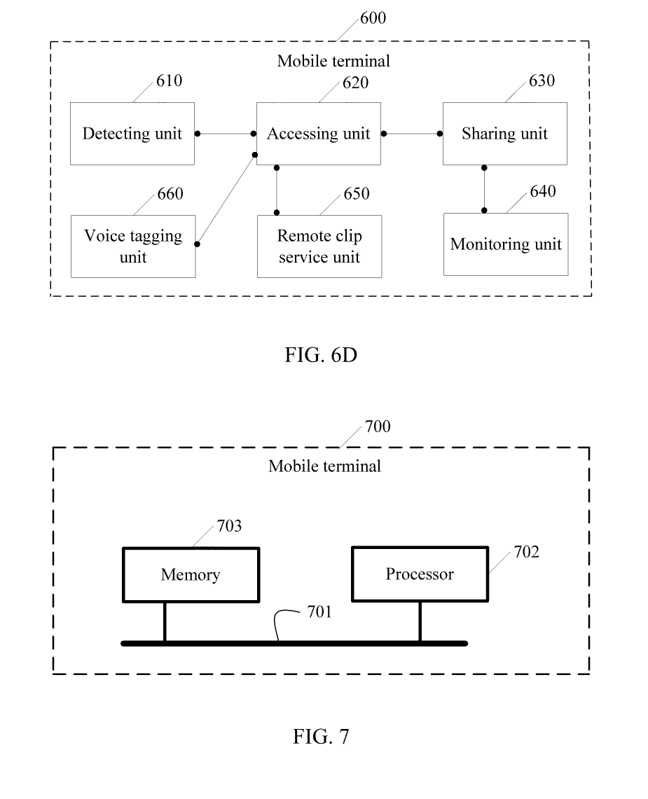

Refer to FIG. 6A, an embodiment of the present invention further provides a mobile terminal 600, which may include a detecting unit 610, an accessing unit 620, and a sharing unit 630.

The detecting unit 610 is configured to detect whether a first mobile terminal initiated a screen sharing service.

The accessing unit 620 is configured to send a screen sharing service access request that corresponds to the screen sharing service to the first mobile terminal by using a wireless local area network after detecting that the first mobile terminal initiated the screen sharing service.

Both the first mobile terminal and the mobile terminal 600 are located in the wireless local area network.

The sharing unit 630 is configured to receive a first video stream from the first mobile terminal, and display the first video stream on a second area in a screen of the mobile terminal, where the first video stream is obtained by the first mobile terminal by encoding content displayed on a first area in a screen of the first mobile terminal.

In some embodiments of the present invention, the detecting unit 610 may be specifically configured to: after receiving, by using the wireless local area network, a screen sharing service enabling message that is corresponding to the screen sharing service and from the first mobile terminal, determine that the first mobile terminal enabled the screen sharing service; or broadcast a screen sharing service enabling query request in the wireless local area network, or send a screen sharing service enabling query request to the first mobile terminal by using the wireless local area network; and when a screen sharing service enabling message that is corresponding to the screen sharing service and from the first mobile terminal is received, determine that the first mobile terminal enabled the screen sharing service.

Refer to FIG. 6B, in some embodiments of the present invention, the mobile terminal 600 may further include: a monitoring unit 640 configured to monitor a first user operation event of a user for the second area after the first video stream is displayed on the second area in the screen of the mobile terminal 600, and send the first user operation event to the first mobile terminal by using the wireless local area network when the first user operation event of the user for the second area is detected, so that the first mobile terminal executes the first user operation event.

Refer to FIG. 6C, in some embodiments of the present invention, the mobile terminal 600 may further include a remote clip service unit 650 configured to access a remote clip service enabled by the first mobile terminal, and when a clipping object from the first mobile terminal is received by using the wireless local area network, update a system clipboard with the received clipping object, where the clipping object is a clipping object that is updated on a system clipboard of the first mobile terminal.

Refer to FIG. 6D, in some embodiments of the present invention, the mobile terminal 600 may further include: a voice tagging unit 660 configured to: when a document is displayed on the second area, when a voice-tagging service enabling indication from the first mobile terminal is received, record a voice tag and send the recorded voice tag to the first mobile terminal, so that the first mobile terminal stores the voice tag and records an association relationship between the voice tag and a first document, where the first document is a document displayed on the second area during duration of recording the voice tag; or, when a picture is displayed on the second area, when a voice-tagging service enabling indication from the first mobile terminal is received, record a voice tag and send the recorded voice tag to the first mobile terminal, so that the first mobile terminal stores the voice tag and records an association relationship between the voice tag and a first picture, where the first picture is a picture displayed on the second area during duration of recording the voice tag; or, when a video is displayed on the second area, when a voice-tagging service enabling indication from the first mobile terminal is received, record a voice tag and send the recorded voice tag to the first mobile terminal, so that the first mobile terminal stores the voice tag and records an association relationship between the voice tag and a first video, where the first video is a video displayed on the second area during duration of recording the voice tag.

It may be understood that functions of functional modules of the mobile terminal 600 according to this embodiment may be specifically implemented according to the method in the foregoing method embodiment, and the mobile terminal 600 may be configured to implement the functions that need to be implemented by the second mobile terminal, where reference may be made to the related description of the foregoing method embodiment for a specific implementation process of the mobile terminal, which is not described repeatedly herein.

FIG. 7 is a schematic structural diagram of a mobile terminal provided by the present invention. As shown in FIG. 7, a mobile terminal 700 according to this embodiment includes at least one bus 701, at least one processor 702 connected to the bus 701, and at least one memory 703 connected to the bus 701.

The processor 702 invokes, by using the bus 701, code stored in the memory 703, so as to initiate a screen sharing service; receives, by using a wireless local area network, a screen sharing service access request that is corresponding to the screen sharing service and from N second mobile terminal(s), where both the mobile terminal 700 and the N second mobile terminal(s) are located in the wireless local area network, and N is a positive integer; and when the N second mobile terminal(s) are allowed to access the screen sharing service, encodes content displayed on a first area in a screen of the mobile terminal 700 into a first video stream, and sends the first video stream to the N second mobile terminal(s) by using the wireless local area network.

In some embodiments of the present invention, the initiating, by the processor 702, a screen sharing service may include: broadcasting, in the wireless local area network by the processor 702, a screen sharing service enabling message that corresponds to the screen sharing service, where the screen sharing service access request that corresponds to the screen sharing service is sent by the second mobile terminal after receiving the screen sharing service enabling message.

In addition, in some other embodiments of the present invention, the initiating, by the processor 702, a screen sharing service may also include: receiving, by the first mobile terminal, a screen sharing service enabling query request from the N second mobile terminal(s), and broadcasting, in the wireless local area network, a screen sharing service enabling message that corresponds to the screen sharing service, or sending a screen sharing service enabling message used for responding to the screen sharing service enabling query request to the N second mobile terminal(s), where the screen sharing service access request that corresponds to the screen sharing service is sent by the second mobile terminal after receiving the screen sharing service enabling message.

It may be understood that, after receiving the screen sharing service access request from the second mobile terminal, the processor 702 may send a screen sharing service reject access message to the second mobile terminal (or does not reply with any messages) when the second mobile terminal is not allowed to access the screen sharing service, and may send a screen sharing service allow access message to the second mobile terminal when the second mobile terminal is allowed to access the screen sharing service.

The processor 702 may select an area (which is referred to as a first area for ease of citation) of the screen of the mobile terminal 700 as a screen sharing area. The mobile terminal 700 may display content, such as a picture, a video, a document, or the desktop, on the first area.

In some embodiments of the present invention, the mobile terminal 700 is used as a WiFi hotspot, and the N second mobile terminal(s) access the wireless local area network by using the WiFi hotspot (refer to FIG. 3A). Alternatively, one second mobile terminal of the N second mobile terminal(s) is used as a WiFi hotspot, and the mobile terminal 700 and remaining second mobile terminals of the N second mobile terminal(s) except the one second mobile terminal access the wireless local area network by using the WiFi hotspot (refer to FIG. 3B). Alternatively, the mobile terminal 700 is used as a group owner, and the N second mobile terminal(s) are used as group clients and access the wireless local area network in a WiFi Direct mode (refer to FIG. 3C). Alternatively, the mobile terminal 700 and the N second mobile terminal(s) access the wireless local area network by using a third-party WiFi hotspot (refer to FIG. 3E). Certainly, the mobile terminal 700 and the N second mobile terminal(s) may also access the same wireless local area network in another manner.

In some embodiments of the present invention, the processor 702 may send the first video stream to the N second mobile terminal(s) based on a multicast or unicast manner by using the wireless local area network. For example, the mobile terminal 700 may include a video stream buffer queue and a blocking buffer queue; for the unicast manner, the processor 702 may put video frames of the first video stream into the video stream buffer queue one by one according to a first-in-first-out principle, where when a first video frame stored by an X^{th} queue unit in the video stream buffer queue is to be replaced with a second video frame in the first video stream, when the first video frame still is not successfully sent to K4 second mobile terminals of the N second mobile terminal(s) (that is, the K4 second mobile terminals failed to obtain the first video frame), the first video frame is written into a queue unit that is in the blocking buffer queue and corresponding to the K4 second mobile terminals (where at least one queue unit in the blocking buffer queue corresponds to each second mobile terminal of the N second mobile terminal(s)), and then the first video frame stored by the X^{th} queue unit is replaced with the second video frame. For each second mobile terminal of the N second mobile terminal(s), the processor 702 may send a video frame, which is read from the video stream buffer queue and/or blocking buffer queue, in the first video stream to each second mobile terminal.

In some embodiments of the present invention, the processor 702 executes the first user operation event when a first user operation event from the second mobile terminal is received by using the wireless local area network, where the first user operation event is a user operation event for a second area in a screen of the second mobile terminal, and the first video stream received by the second mobile terminal is displayed on the second area. The processor 702 may add the first user operation event into a system operation event linked list, and execute the first user operation event according to an execution sequence of events in the system operation event linked list. The first user operation event may be a plurality of user operation events for the second area in the screen of the second mobile terminal. Assuming that an animation is displayed on the second area, the first user operation event may be, for example, a user operation event used for adjusting a speed, brightness, contrast, and/or a size of the animation displayed on the second area. Assuming that a desktop including a plurality of application icons is displayed on the second area, the first user operation event may be, for example, a user operation event for starting an application corresponding to an application icon in the desktop displayed on the second area, and a user operation event of another function may be similar.

If necessary, the second mobile terminal may convert the detected user operation event for the second area in the screen of the second mobile terminal into a first user operation event of a specified format (for example, the processor 702 specified a format of a user operation event), and send the first user operation event to the mobile terminal 700 by using the wireless local area network, so that the mobile terminal 700 executes the first user operation event. Certainly, if the mobile terminal 700 and the second mobile terminal are of the same system type, and the processor 702 can identify the user operation event detected by the second mobile terminal, the second mobile terminal may send the detected user operation event to the mobile terminal 700 without performing format conversion.

In some embodiments of the present invention, screen sharing may further support a doodle function. For example, a transparent layer may be covered over the first area of the processor 702, and the first user operation event is a doodle drawing event, where the executing, by the processor 702, the first user operation event when the first user operation event from the second mobile terminal is received by using the wireless local area network includes: displaying, by the processor 702, a doodle drawn by the doodle drawing event on the transparent layer when a doodle drawing event from the second mobile terminal is received by using the wireless local area network, where the drawn doodle may also be shared with other screen sharing service accessing parties.

In some embodiments of the present invention, the processor 702 may further collect a sound signal played by the mobile terminal 700, encode the collected sound signal into a first audio stream, and interleave the first audio stream into the first video stream; or the processor 702 decodes an audio file to obtain a first audio stream, and interleaves the first audio stream into the first video stream.

The sending, by the processor 702, the first video stream to the N second mobile terminal(s) by using the wireless local area network may include sending the first video stream interleaved with the first audio stream to the N second mobile terminal(s) by using the wireless local area network. In this case, the mobile terminal 700 may release a voice instruction, play background music, and the like to the second mobile terminal on this basis.

In some embodiments of the present invention, a bit rate of the first video stream may be constant. Alternatively, a bit rate of the first video stream may correspond to a value of N. For example, when the number of mobile terminals accessing the screen sharing service changes, the processor 702 may dynamically adjust a bit rate of the video stream. For example, when detecting that the number of mobile terminals accessing the screen sharing service changes, the processor 702 may adjust the bit rate of the video stream according to the changed number of mobile terminals accessing the screen sharing service. Assuming that a bit rate of a video stream is A when only one mobile terminal accesses the screen sharing service, but the current number of mobile terminals accessing the screen sharing service is N, a current bit rate of the video stream may be A/N. That is, the larger number of mobile terminals accessing the screen sharing service causes a lower bit rate of the video stream. Alternatively, the bit rate of the first video stream may correspond to a type of the content displayed on the first area. For example, when a type of content currently displayed by the processor 702 on the first area is a high-dynamic image (such as a video and an interface animation), the processor 702 may increase a frame rate of the first video stream and reduce a frame size of the first video stream, so as to improve fluency of the first video stream; when the type of the content currently displayed by the processor 702 on the first area is not a high-dynamic image, the processor 702 may reduce the frame rate of the video stream and improve the frame size of the video stream, so as to improve resolution of the first video stream.

It may be understood that the processor 702 may determine, according to whether a mobile terminal accesses the screen sharing service, whether to start encoding the first video stream. For example, when no mobile terminal accesses the screen sharing service, encoding of the first video stream is not started; when at least one mobile terminal accesses the screen sharing service, encoding of the first video stream is started; and when all mobile terminals accessing the screen sharing service disconnect, the processor 702 may stop encoding the first video stream. Certainly, the processor 702 may also keep encoding the first video stream during duration of initiating the screen sharing service.

In some embodiments of the present invention, the processor 702 may further start a remote clip service; if M second mobile terminal(s) of the N second mobile terminal(s) access the remote clip service by using the wireless local area network, when monitoring that there is an updated clipping object on a system clipboard of the mobile terminal 700, the processor 702 may send the clipping object to the M second mobile terminal(s) by using the wireless local area network, so that the M second mobile terminal(s) update system clipboards of the M second mobile terminal(s) with the clipping object received by the M second mobile terminal(s).

In some embodiments of the present invention, voice tagging may be further implemented when screen sharing is performed. For example, the processor 702 may further send a voice-tagging service enabling indication to K1 second mobile terminal(s) of the N second mobile terminal(s) when the processor 702 displays a document on the first area in the screen of the mobile terminal 700, and when a voice tag that is recorded by a part of or all second mobile terminals of the K1 second mobile terminal(s) after receiving the voice-tagging service enabling indication is received, store the voice tag and record an association relationship between the voice tag and a first document, where the first document is a document that is displayed by the processor 702 on the first area in the screen of the mobile terminal 700 during duration of recording the voice tag. Further, when opening the first document again, the processor 702 may play the voice tag that has the association relationship with the first document. It may be understood that K1 is less than or equal to N.

For another example, the processor 702 sends a voice-tagging service enabling indication to K2 second mobile terminal(s) of the N second mobile terminal(s) when the processor 702 displays a picture on the first area in the screen of the mobile terminal 700, and when a voice tag that is recorded by a part of or all second mobile terminals of the K2 second mobile terminal(s) after receiving the voice-tagging service enabling indication is received, stores the voice tag and records an association relationship between the voice tag and a first picture, where the first picture is a picture that is displayed by the processor 702 on the first area in the screen of the mobile terminal 700 during duration of recording the voice tag. Further, when opening the first picture again, the processor 702 may play the voice tag that has the association relationship with the first picture. It may be understood that K2 is less than or equal to N.

For another example, the processor 702 sends a voice-tagging service enabling indication to K3 second mobile terminal(s) of the N second mobile terminal(s) when the processor 702 displays a video on the first area in the screen of the mobile terminal 700, and when a voice tag that is recorded by a part of or all second mobile terminals of the K3 second mobile terminal(s) after receiving the voice-tagging service enabling indication is received, stores the voice tag and records an association relationship between the voice tag and a first video, where the first video is a video that is displayed by the processor 702 on the first area in the screen of the mobile terminal 700 during duration of recording the voice tag. Voice tagging may be performed in another scenario according to a similar manner. Further, when opening the first video again, the processor 702 may play the voice tag that has the association relationship with the first video. It may be understood that K3 is less than or equal to N.

The following describes function implementation by assuming that the mobile terminal 700 is used as a service accessing party.

In some embodiments of the present invention, the processor 702 may be further configured to detect whether a third mobile terminal initiated a screen sharing service; send a screen sharing service access request that corresponds to the screen sharing service to the third mobile terminal by using a wireless local area network after detecting that the first mobile terminal initiated the screen sharing service, where both the third mobile terminal and the mobile terminal 700 are located in the wireless local area network; and receive a first video stream from the third mobile terminal, and display the first video stream on a fourth area in a screen of the mobile terminal 700, where the first video stream is obtained by the third mobile terminal by encoding content displayed on a third area in a screen of the third mobile terminal.

The processor 702 may detect, in a plurality of manners, whether the third mobile terminal initiated the screen sharing service. For example, the detecting, by the processor 702, whether the third mobile terminal initiated the screen sharing service may include: after receiving, by using the wireless local area network, a screen sharing service enabling message that is corresponding to the screen sharing service and from the third mobile terminal, determining that it is detected that the third mobile terminal enabled the screen sharing service; or broadcasting a screen sharing service enabling query request in the wireless local area network, or sending a screen sharing service enabling query request to the third mobile terminal by using the wireless local area network; and when the screen sharing service enabling message that is corresponding to the screen sharing service and from the third mobile terminal is received, determining that it is detected that the third mobile terminal enabled the screen sharing service.

In some embodiments of the present invention, after the processor 702 displays the first video stream on the fourth area in the screen of the mobile terminal 700, the method further includes: monitoring a first user operation event of a user for the fourth area, and sending the first user operation event to the third mobile terminal by using the wireless local area network when the first user operation event of the user for the fourth area is detected, so that the third mobile terminal executes the first user operation event.

In some embodiments of the present invention, the third mobile terminal may be used as a WiFi hotspot, and the mobile terminal 700 accesses the wireless local area network by using the WiFi hotspot; or the mobile terminal 700 is used as a WiFi hotspot, and the third mobile terminal accesses the wireless local area network by using the WiFi hotspot; or the third mobile terminal is used as a group owner, and the mobile terminal 700 accesses the wireless local area network as a group client in a WiFi Direct mode; or the mobile terminal 700 is used as a group owner, and the third mobile terminal accesses the wireless local area network as a group client in a WiFi Direct mode; or the third mobile terminal and the mobile terminal 700 access the wireless local area network by using a third-party WiFi hotspot.

In some embodiments of the present invention, a transparent layer is covered over the third area of the third mobile terminal, and the first user operation event is a doodle drawing event, where the sending the first user operation event to the third mobile terminal by using the wireless local area network when the first user operation event of the user for the fourth area is detected, so that the third mobile terminal executes the first user operation event includes: sending the doodle drawing event to the third mobile terminal by using the wireless local area network when a doodle drawing event of the user for the fourth area is detected, so that the third mobile terminal displays, on the transparent layer, a doodle drawn by the doodle drawing event.

In some embodiments of the present invention, the mobile terminal 700 may further access a remote clip service enabled by the third mobile terminal; when a clipping object from the third mobile terminal is received by using the wireless local area network, update a system clipboard with the received clipping object, where the clipping object is a clipping object that is updated on a system clipboard of the third mobile terminal.

In some embodiments of the present invention, the method further includes: when a document is displayed on the fourth area, when a voice-tagging service enabling indication from the third mobile terminal is received, recording a voice tag and sending the recorded voice tag to the third mobile terminal, so that the third mobile terminal stores the voice tag and records an association relationship between the voice tag and a first document, where the first document is a document displayed on the fourth area during duration of recording the voice tag; and/or when a picture is displayed on the fourth area, when a voice-tagging service enabling indication from the third mobile terminal is received, recording a voice tag and sending the recorded voice tag to the third mobile terminal, so that the third mobile terminal stores the voice tag and records an association relationship between the voice tag and a first picture, where the first picture is a picture displayed on the fourth area during duration of recording the voice tag; and/or when a video is displayed on the fourth area, when a voice-tagging service enabling indication from the third mobile terminal is received, recording a voice tag and sending the recorded voice tag to the third mobile terminal, so that the third mobile terminal stores the voice tag and records an association relationship between the voice tag and a first video, where the first video is a video displayed on the fourth area during duration of recording the voice tag.

The mobile terminal 700 provided by this embodiment may be configured to execute a part that is correspondingly executed by the mobile terminal 700 in the technical solution according to the method embodiment shown in FIG. 1 or FIG. 3G; moreover, in some scenarios, the mobile terminal 700 may also be configured to execute a part that is correspondingly executed by the second mobile terminal in the technical solution according to the method embodiment shown in FIG. 1 or FIG. 3G, where implementation principles and technical effects thereof are the same, which are not described repeatedly herein. FIG. 7 is merely a schematic diagram of a structure of a mobile terminal provided by the present invention, where a specific structure may be adjusted according to an actual condition.

It may be understood that, functions of the functional modules of the mobile terminal 700 according to this embodiment may be specifically implemented according to the method in the foregoing method embodiment, where reference may be made to the related description of the foregoing method embodiment for a specific implementation process of the mobile terminal, which is not described repeatedly herein.

It can be seen that, in this embodiment, after a mobile terminal 700 enables a screen sharing service that a plurality of mobile terminals is allowed to access, when N second mobile terminal(s) access, by using a wireless local area network, the screen sharing service enabled by the mobile terminal 700, the mobile terminal 700 encodes content displayed on a first area in a screen of the mobile terminal 700 into a first video stream, and sends the first video stream to the N second mobile terminal(s) by using the wireless local area network. Because both the mobile terminal 700 and the N second mobile terminal(s) access the same wireless local area network, the mobile terminal 700 and the N second mobile terminal(s) perform the screen sharing service based on the wireless local area network, and exchange data related to the screen sharing service. Screen sharing data exchange implemented based on the wireless local area network may address an issue of screen sharing within a small range without a large-scale external server or an external network, and may achieve an effect that is easy-to-use, simple, and practical. Moreover, with a high transmission rate of the wireless local area network, the access is simple and access by a plurality of terminals is supported, so that the screen sharing technology according to the embodiments of the present invention can better support a scenario that has a high requirement on fluency and real-time quality, which also helps to enhance flexibility for participating in screen sharing, so as to increase the number of participants of screen sharing.

Further, a different encoding method may be used according to a difference in a type of content currently displayed on the screen, which helps to solve a problem of balancing a fluency requirement in a scenario that requires high fluency, such as a video or an interface animation, and a resolution requirement in a scenario of displaying a picture, thereby helping to achieve an effect that an encoded video stream dynamically responds to a scenario requirement when a scenario displayed on the screen is switched.

Further, a video stream buffer queue and a blocking buffer queue that are used in cooperation are introduced into the mobile terminal initiating the screen sharing service, which helps to save a memory overhead in a scenario in which a plurality of mobile terminals accesses the screen sharing service, and implement that video streams do not affect each other, thereby achieving a technical effect of saving a memory overhead and a time overhead without affecting the video streams.

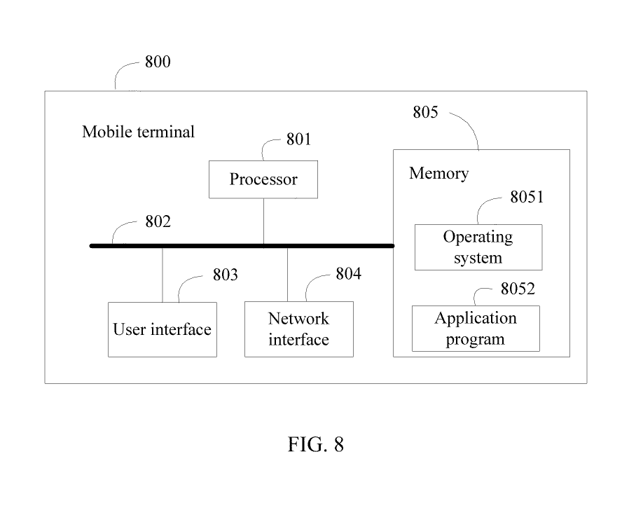

FIG. 8 shows a structure of a communications terminal 800 provided by an embodiment of the present invention. The communications terminal 800 includes at least one processor 801, for example, a central processing unit (CPU), at least one network interface 804 or another user interface 803, a memory 805, and at least one communication bus 802. The communication bus 802 is configured to implement communication connection between the components. Optionally, the communications terminal 800 includes the user interface 803, which includes a monitor, a keyboard or a clicking device (for example, a mouse, a trackball, a touch pad, or a touch screen). The memory 805 may include a high-speed random-access memory (RAM), and may also include a non-volatile memory, such as at least one disk memory. Optionally, the memory 805 may include at least one storage apparatus far away from the processor 801.

In some implementation manners, the memory 805 stores the following elements, an executable module or data structure, or a subset thereof, or an extension set thereof: an operating system 8051, including various system programs and configured to implement various basic services and process a hardware-based task; and an application program module 8052, including various application programs and configured to implement various application services.

The application program module 8052 includes but is not limited to a service initiating unit 510 and a sharing unit 520.

Further, the application program module 8052 may further include an event response unit 530, an audio processing unit 540, a remote clip service unit 550, and a voice tagging unit 560.

Reference may be made to corresponding modules in the embodiment shown in FIG. 5A to FIG. 5E for a specific implementation of various modules in the application program module 8052, which will not be described repeatedly herein.

In some embodiments of the present invention, by invoking a program or an instruction stored in the memory 805, the processor 801 may be configured to: initiate a screen sharing service; receive, by using a wireless local area network, a screen sharing service access request that is corresponding to the screen sharing service and from N second mobile terminal(s), where both the mobile terminal 800 and the N second mobile terminal(s) are located in the wireless local area network, and N is a positive integer; and when the N second mobile terminal(s) are allowed to access the screen sharing service, encode content displayed on a first area in a screen of the mobile terminal 800 into a first video stream, and send the first video stream to the N second mobile terminal(s) by using the wireless local area network.

In some embodiments of the present invention, the initiating, by the processor 801, a screen sharing service may include broadcasting, in the wireless local area network by the first mobile terminal, a screen sharing service enabling message that corresponds to the screen sharing service, where the screen sharing service access request that corresponds to the screen sharing service is sent by the second mobile terminal after receiving the screen sharing service enabling message.

In addition, in some other embodiments of the present invention, the initiating, by the processor 801, a screen sharing service may also include receiving, by the first mobile terminal, a screen sharing service enabling query request from the N second mobile terminal(s), and broadcasting, in the wireless local area network, a screen sharing service enabling message that corresponds to the screen sharing service, or sending a screen sharing service enabling message used for responding to the screen sharing service enabling query request to the N second mobile terminal(s), where the screen sharing service access request that corresponds to the screen sharing service is sent by the second mobile terminal after receiving the screen sharing service enabling message.

It may be understood that, after receiving the screen sharing service access request from the second mobile terminal, the processor 801 may send a screen sharing service reject access message to the second mobile terminal (or does not reply with any messages) when the second mobile terminal is not allowed to access the screen sharing service, and may send a screen sharing service allow access message to the second mobile terminal when the second mobile terminal is allowed to access the screen sharing service.

The processor 801 may select an area (which is referred to as a first area for ease of citation) of the screen of the mobile terminal 800 as a screen sharing area. The mobile terminal 800 may display content, such as a picture, a video, a document, or the desktop, on the first area.

In some embodiments of the present invention, the mobile terminal 800 is used as a WiFi hotspot, and the N second mobile terminal(s) access the wireless local area network by using the WiFi hotspot (refer to FIG. 3A). Alternatively, one second mobile terminal of the N second mobile terminal(s) is used as a WiFi hotspot, and the mobile terminal 800 and remaining second mobile terminals of the N second mobile terminal(s) except the one second mobile terminal access the wireless local area network by using the WiFi hotspot (refer to FIG. 3B). Alternatively, the mobile terminal 800 is used as a group owner, and the N second mobile terminal(s) are used as group clients and access the wireless local area network in a WiFi Direct mode (refer to FIG. 3C). Alternatively, the mobile terminal 800 and the N second mobile terminal(s) access the wireless local area network by using a third-party WiFi hotspot (refer to FIG. 3D). Certainly, the mobile terminal 800 and the N second mobile terminal(s) may also access the same wireless local area network in another manner.

In some embodiments of the present invention, the processor 801 may send the first video stream to the N second mobile terminal(s) based on a multicast or unicast manner by using the wireless local area network. For example, the mobile terminal 800 may include a video stream buffer queue and a blocking buffer queue; for the unicast manner, the processor 801 may put video frames of the first video stream into the video stream buffer queue one by one according to a first-in-first-out principle, where when a first video frame stored by an X^{th} queue unit in the video stream buffer queue is to be replaced with a second video frame in the first video stream, when the first video frame still is not successfully sent to K4 second mobile terminals of the N second mobile terminal(s) (that is, the K4 second mobile terminals failed to obtain the first video frame), the first video frame is written into a queue unit that is in the blocking buffer queue and corresponding to the K4 second mobile terminals (where at least one queue unit in the blocking buffer queue corresponds to each second mobile terminal of the N second mobile terminal(s)), and then the first video frame stored by the X^{th} queue unit is replaced with the second video frame. For each second mobile terminal of the N second mobile terminal(s), the processor 801 may send a video frame, which is read from the video stream buffer queue and/or blocking buffer queue, in the first video stream to each second mobile terminal.

In some embodiments of the present invention, the processor 801 executes the first user operation event when a first user operation event from the second mobile terminal is received by using the wireless local area network, where the first user operation event is a user operation event for a second area in a screen of the second mobile terminal, and the first video stream received by the second mobile terminal is displayed on the second area. The processor 801 may add the first user operation event into a system operation event linked list, and execute the first user operation event according to an execution sequence of events in the system operation event linked list. The first user operation event may be a plurality of user operation events for the second area in the screen of the second mobile terminal. Assuming that an animation is displayed on the second area, the first user operation event may be, for example, a user operation event used for adjusting a speed, brightness, contrast, and/or a size of the animation displayed on the second area. Assuming that a desktop including a plurality of application icons is displayed on the second area, the first user operation event may be, for example, a user operation event for starting an application corresponding to an application icon in the desktop displayed on the second area, and a user operation event of another function may be similar.

If necessary, the second mobile terminal may convert the detected user operation event for the second area in the screen of the second mobile terminal into a first user operation event of a specified format (for example, the processor 801 specified a format of user operation events), and send the first user operation event to the mobile terminal 800 by using the wireless local area network, so that the mobile terminal 800 executes the first user operation event. Certainly, if the mobile terminal 800 and the second mobile terminal are of the same system type, and the processor 801 can identify the user operation event detected by the second mobile terminal, the second mobile terminal may send the detected user operation event to the mobile terminal 800 without performing format conversion.

In some embodiments of the present invention, screen sharing may further support a doodle function. For example, a transparent layer may be covered over the first area of the processor 801, and the first user operation event is a doodle drawing event, where the executing, by the processor 801, the first user operation event when the first user operation event from the second mobile terminal is received by using the wireless local area network includes: displaying, by the processor 801, a doodle drawn by the doodle drawing event on the transparent layer when a doodle drawing event from the second mobile terminal is received by using the wireless local area network, where the drawn doodle may also be shared with other screen sharing service accessing parties.

In some embodiments of the present invention, the processor 801 may further collect a sound signal played by the mobile terminal 800, encode the collected sound signal into a first audio stream, and interleave the first audio stream into the first video stream; or the processor 801 decodes an audio file to obtain a first audio stream, and interleaves the first audio stream into the first video stream.

The sending, by processor 801, the first video stream to the N second mobile terminal(s) by using the wireless local area network may include: sending the first video stream interleaved with the first audio stream to the N second mobile terminal(s) by using the wireless local area network. In this case, the mobile terminal 800 may release a voice instruction, play background music, and the like to the second mobile terminal on this basis.

In some embodiments of the present invention, a bit rate of the first video stream may be constant. Alternatively, a bit rate of the first video stream may correspond to a value of N. For example, when the number of mobile terminals accessing the screen sharing service changes, the processor 801 may dynamically adjust a bit rate of the video stream. For example, when detecting that the number of mobile terminals accessing the screen sharing service changes, the processor 801 may adjust the bit rate of the video stream according to the changed number of mobile terminals accessing the screen sharing service. Assuming that a bit rate of a video stream is A when only one mobile terminal accesses the screen sharing service, but the current number of mobile terminals accessing the screen sharing service is N, a current bit rate of the video stream may be A/N. That is, the larger number of mobile terminals accessing the screen sharing service causes a lower bit rate of the video stream. Alternatively, the bit rate of the first video stream may correspond to a type of the content displayed on the first area. For example, when a type of content currently displayed by the processor 801 on the first area is a high-dynamic image (such as a video and an interface animation), the processor 801 may increase a frame rate of the first video stream and reduce a frame size of the first video stream, so as to improve fluency of the first video stream; when the type of the content currently displayed by the processor 801 on the first area is not a high-dynamic image, the processor 801 may reduce the frame rate of the video stream and improve the frame size of the video stream, so as to improve resolution of the first video stream.

It may be understood that the processor 801 may determine, according to whether a mobile terminal accesses the screen sharing service, whether to start encoding the first video stream. For example, when no mobile terminal accesses the screen sharing service, encoding of the first video stream is not started; when at least one mobile terminal accesses the screen sharing service, encoding of the first video stream is started; and when all mobile terminals accessing the screen sharing service disconnect, the processor 801 may stop encoding the first video stream. Certainly, the processor 801 may also keep encoding the first video stream during duration of initiating the screen sharing service.

In some embodiments of the present invention, the processor 801 may further start a remote clip service; when M second mobile terminal(s) of the N second mobile terminal(s) access the remote clip service by using the wireless local area network, when monitoring that there is an updated clipping object on a system clipboard of the mobile terminal 801, the processor 800 may send the clipping object to the M second mobile terminal(s) by using the wireless local area network, so that the M second mobile terminal(s) update system clipboards of the M second mobile terminal(s) with the clipping object received by the M second mobile terminal(s).

In some embodiments of the present invention, voice tagging may be further implemented when screen sharing is performed. For example, the processor 801 may further send a voice-tagging service enabling indication to K1 second mobile terminal(s) of the N second mobile terminal(s) when the processor 800 displays a document on the first area in the screen of the mobile terminal 801, and when a voice tag that is recorded by a part of or all second mobile terminals of the K1 second mobile terminal(s) after receiving the voice-tagging service enabling indication is received, store the voice tag and record an association relationship between the voice tag and a first document, where the first document is a document that is displayed by the processor 801 on the first area in the screen of the mobile terminal 800 during duration of recording the voice tag. Further, when opening the first document again, the processor 801 may play the voice tag that has the association relationship with the first document. It may be understood that K1 is less than or equal to N.

For another example, the processor 801 sends a voice-tagging service enabling indication to K2 second mobile terminal(s) of the N second mobile terminal(s) when the processor 800 displays a picture on the first area in the screen of the mobile terminal 801, and when a voice tag that is recorded by a part of or all second mobile terminals of the K2 second mobile terminal(s) after receiving the voice-tagging service enabling indication is received, stores the voice tag and records an association relationship between the voice tag and a first picture, where the first picture is a picture that is displayed by the processor 801 on the first area in the screen of the mobile terminal 800 during duration of recording the voice tag. Further, when opening the first picture again, the processor 801 may play the voice tag that has the association relationship with the first picture. It may be understood that K2 is less than or equal to N.

For another example, the processor 801 sends a voice-tagging service enabling indication to K3 second mobile terminal(s) of the N second mobile terminal(s) when the processor 800 displays a video on the first area in the screen of the mobile terminal 801, and when a voice tag that is recorded by a part of or all second mobile terminals of the K3 second mobile terminal(s) after receiving the voice-tagging service enabling indication is received, stores the voice tag and records an association relationship between the voice tag and a first video, where the first video is a video that is displayed by the processor 801 on the first area in the screen of the mobile terminal 800 during duration of recording the voice tag. Voice tagging may be performed in another scenario according to a similar manner. Further, when opening the first video again, the processor 801 may play the voice tag that has the association relationship with the first video. It may be understood that K3 is less than or equal to N.

The following describes function implementation by assuming that the mobile terminal 800 is used as a service accessing party.

In some embodiments of the present invention, the processor 801 may be further configured to detect whether a third mobile terminal initiates a screen sharing service; send a screen sharing service access request that corresponds to the screen sharing service to the third mobile terminal by using a wireless local area network after detecting that the third mobile terminal initiated the screen sharing service, where both the third mobile terminal and the mobile terminal 800 are located in the wireless local area network; and receive a first video stream from the third mobile terminal, and display the first video stream on a fourth area in a screen of the mobile terminal 800, where the first video stream is obtained by the third mobile terminal by encoding content displayed on a third area in a screen of the third mobile terminal.

The processor 801 may detect, in a plurality of manners, whether the third mobile terminal initiated the screen sharing service. For example, the detecting, by the processor 801, whether the third mobile terminal initiated the screen sharing service may include: after receiving, by using the wireless local area network, a screen sharing service enabling message that is corresponding to the screen sharing service and from the third mobile terminal, determining that it is detected that the third mobile terminal enabled the screen sharing service; or broadcasting a screen sharing service enabling query request in the wireless local area network, or sending a screen sharing service enabling query request to the third mobile terminal by using the wireless local area network; and when the screen sharing service enabling message that is corresponding to the screen sharing service and from the third mobile terminal is received, determining that it is detected that the third mobile terminal enabled the screen sharing service.

In some embodiments of the present invention, after the processor 801 displays the first video stream on the fourth area in the screen of the mobile terminal 800, the method further includes: monitoring a first user operation event of a user for the fourth area, and sending the first user operation event to the third mobile terminal by using the wireless local area network when the first user operation event of the user for the fourth area is detected, so that the third mobile terminal executes the first user operation event.

In some embodiments of the present invention, the third mobile terminal may be used as a WiFi hotspot, and the mobile terminal 800 accesses the wireless local area network by using the WiFi hotspot; or the mobile terminal 800 is used as a WiFi hotspot, and the third mobile terminal accesses the wireless local area network by using the WiFi hotspot; or the third mobile terminal is used as a group owner, and the mobile terminal 800 accesses the wireless local area network as a group client in a WiFi Direct mode; or the mobile terminal 800 is used as a group owner, and the third mobile terminal accesses the wireless local area network as a group client in a WiFi Direct mode; or the third mobile terminal and the mobile terminal 800 access the wireless local area network by using a third-party WiFi hotspot.

In some embodiments of the present invention, a transparent layer is covered over the third area of the third mobile terminal, and the first user operation event is a doodle drawing event, where the sending the first user operation event to the third mobile terminal by using the wireless local area network when the first user operation event of the user for the fourth area is detected, so that the third mobile terminal executes the first user operation event includes: sending the doodle drawing event to the third mobile terminal by using the wireless local area network when a doodle drawing event of the user for the fourth area is detected, so that the third mobile terminal displays, on the transparent layer, a doodle drawn by the doodle drawing event.

In some embodiments of the present invention, the mobile terminal 800 may further access a remote clip service enabled by the third mobile terminal; when a clipping object from the third mobile terminal is received by using the wireless local area network, update a system clipboard with the received clipping object, where the clipping object is a clipping object that is updated on a system clipboard of the third mobile terminal.

In some embodiments of the present invention, the method further includes: when a document is displayed on the fourth area, when a voice-tagging service enabling indication from the third mobile terminal is received, recording a voice tag and sending the recorded voice tag to the third mobile terminal, so that the third mobile terminal stores the voice tag and records an association relationship between the voice tag and a first document, where the first document is a document displayed on the fourth area during duration of recording the voice tag; and/or when a picture is displayed on the fourth area, when a voice-tagging service enabling indication from the third mobile terminal is received, recording a voice tag and sending the recorded voice tag to the third mobile terminal, so that the third mobile terminal stores the voice tag and records an association relationship between the voice tag and a first picture, where the first picture is a picture displayed on the fourth area during duration of recording the voice tag; and/or when a video is displayed on the fourth area, when a voice-tagging service enabling indication from the third mobile terminal is received, recording a voice tag and sending the recorded voice tag to the third mobile terminal, so that the third mobile terminal stores the voice tag and records an association relationship between the voice tag and a first video, where the first video is a video displayed on the fourth area during duration of recording the voice tag.

It may be understood that, functions of the functional modules of the mobile terminal 800 according to this embodiment may be specifically implemented according to the method in the foregoing method embodiment, where reference may be made to the related description of the foregoing method embodiment for a specific implementation process of the mobile terminal, which is not described repeatedly herein.

It can be seen that, after the foregoing solution is used, after a mobile terminal 800 enables a screen sharing service that a plurality of mobile terminals is allowed to access, when N second mobile terminal(s) access, by using a wireless local area network, the screen sharing service enabled by the mobile terminal 800, the mobile terminal 800 encodes content displayed on a first area in a screen of the mobile terminal 800 into a first video stream, and sends the first video stream to the N second mobile terminal(s) by using the wireless local area network. Because both the mobile terminal 800 and the N second mobile terminal(s) access the same wireless local area network, the mobile terminal 800 and the N second mobile terminal(s) perform the screen sharing service based on the wireless local area network, and exchange data related to the screen sharing service. Screen sharing data exchange implemented based on the wireless local area network may address an issue of screen sharing within a small range without a large-scale external server or an external network, and may achieve an effect that is easy-to-use, simple, and practical. Moreover, with a high transmission rate of the wireless local area network, the access is simple and access by a plurality of terminals is supported, so that the screen sharing technology according to the embodiments of the present invention can better support a scenario that has a high requirement on fluency and real-time quality, which also helps to enhance flexibility for participating in screen sharing, so as to increase the number of participants of screen sharing.

Further, a different encoding method may be used according to a difference in a type of content currently displayed on the screen, which helps to solve a problem of balancing a fluency requirement in a scenario that requires high fluency, such as a video or an interface animation, and a resolution requirement in a scenario of displaying a picture, thereby helping to achieve an effect that an encoded video stream dynamically responds to a scenario requirement when a scenario displayed on the screen is switched.

Further, a video stream buffer queue and a blocking buffer queue that are used in cooperation are introduced into the mobile terminal initiating the screen sharing service, which helps to save a memory overhead in a scenario in which a plurality of mobile terminals accesses the screen sharing service, and implement that video streams do not affect each other, thereby achieving a technical effect of saving a memory overhead and a time overhead without affecting the video streams.

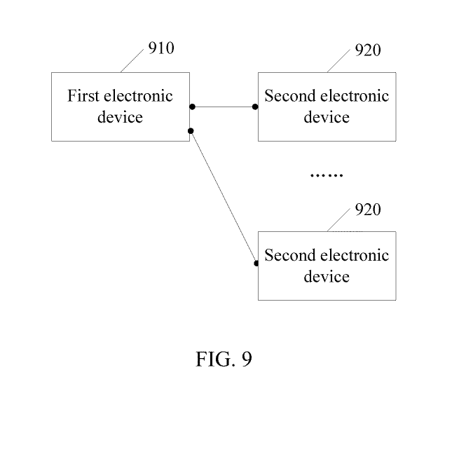

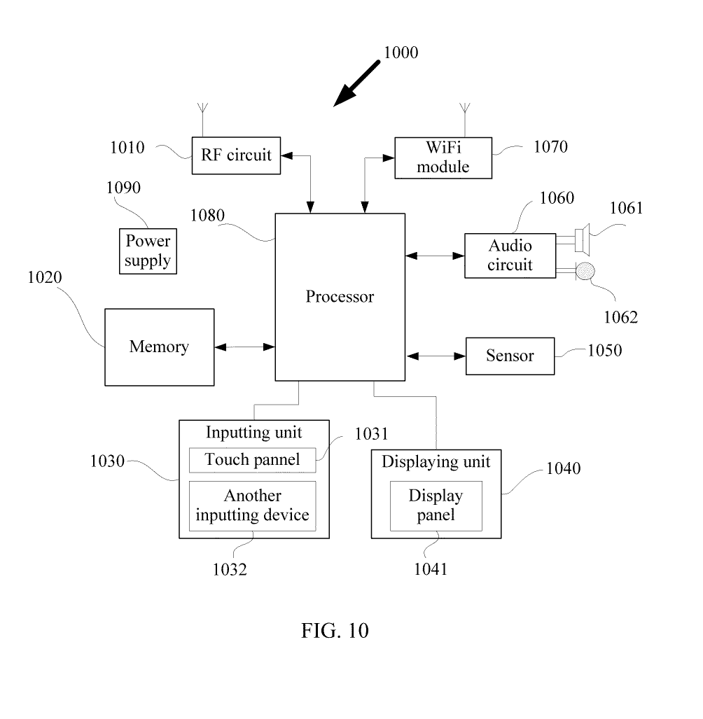

Refer to FIG. 9, an embodiment of the present invention further provides a communications system, which may include a first mobile terminal 910 and N second mobile terminal(s) 920.

Both the first mobile terminal 910 and the N second mobile terminal(s) 920 access a same wireless local area network, and N is a positive integer.

The first mobile terminal 910 is configured to initiate a screen sharing service; receive, by using the wireless local area network, a screen sharing service access request that is corresponding to the screen sharing service and from the N second mobile terminal(s); and when the N second mobile terminal(s) are allowed to access the screen sharing service, encode content displayed on a first area in a screen of the first mobile terminal into a first video stream, and send the first video stream to the N second mobile terminal(s) by using the wireless local area network.

In some embodiments of the present invention, the first mobile terminal 910 may be the mobile terminal 500, the mobile terminal 700, and the mobile terminal 800.

It may be understood that the first mobile terminal 910 according to this embodiment may be configured to implement functions of the first mobile terminal in the foregoing embodiment, where reference may be made to the related description of the foregoing method embodiment for a specific implementation process of the first mobile terminal, which is not described repeatedly herein.

An embodiment of the present invention further provides a schematic diagram of a mobile terminal 1000, where the mobile terminal 1000 may be configured to implement a part of or all functions of the first mobile terminal, the second mobile terminal, the mobile terminal 500, the mobile terminal 600, the mobile terminal 700, and the mobile terminal 800 in the foregoing embodiments.

As shown in FIG. 10, for convenience of description, only a part that may be related to the embodiments of the present invention is shown, and reference may be made to the method part of the embodiments of the present invention for specific technical details that are not disclosed.

FIG. 10 shows a block diagram of a part of structure of a mobile terminal that may be related to a terminal provided by the embodiments of the present invention. Referring to FIG. 10, the mobile terminal includes components, such as a radio frequency (RF) circuit 1010, a memory 1020, an inputting unit 1030, a WiFi module 1070, a displaying unit 1040, a sensor 1050, an audio circuit 1060, a processor 1080, and a power supply 1090.

Persons skilled in the art may understand that, the structure of the mobile terminal shown in FIG. 10 does not constitute a limit to the mobile terminal, where more or less components than those illustrated in the figure may be included, or some components may be combined, or a different component arrangement may be provided.

The RF circuit 1010 may be configured to receive and send a signal in a process of information transceiving or call, and particularly, to send, after receiving downlink information of a base station, the downlink information to the processor 1080 for processing; and moreover, send designed uplink data to the base station. Normally, the RF circuit includes but is not limited to an antenna, at least one amplifier, a transceiver, a coupler, a low-noise amplifier (LNA), and a duplexer. In addition, the RF circuit 1010 may further communicate with a network and another device by using wireless communication. The wireless communication may use any communication standard or protocol, which includes but is not limited to Global System for Mobile Communications (GSM), General Packet Radio Service (GPRS), Code Division Multiple Access (CDMA), Wideband Code Division Multiple Access (WCDMA), long term evolution (LTE), an electronic mail (email), and a short message service (SMS).

The memory 1020 may be configured to store a software program and a module; the processor 1080 executes various functional applications and data processing of the mobile terminal by running the software program and module stored in the memory 1020. The memory 1020 may mainly include a program storage area and a data storage area, where the program storage area may store an operating system, an application program (for example, a sound playing function, an image playing function, and the like) required by at least one function, and the like; and the data storage area may store data (such as audio data and a phone book) that is created according to use of the mobile terminal. In addition, the memory 1020 may include a high-speed random access memory, and may further include a non-volatile memory, for example, at least one disk memory, a flash device, or another volatile solid storage device.

The inputting unit 1030 may be configured to receive entered numeral or character information, and generate a key signal input that is related to a user setting and function control of the mobile terminal 1000. Specifically, the inputting unit 1030 may include a touch panel 1031 and another inputting device 1032. The touch panel 1031 may also be referred to as a touch screen, and may collect a touch operation of a user on or near the touch panel (for example, an operation performed on the touch panel 1031 or near the touch panel 1031 by the user by using any proper object or attachment such as a finger or stylus), and drive a corresponding connection apparatus according to a predefined procedure. Optionally, the touch panel 1031 may include two parts, a touch detecting apparatus and a touch controller. The touch detecting apparatus detects a touch position of the user, detects a signal caused by the touch operation, and transfers the signal to the touch controller; the touch controller receives touch information from the touch detecting apparatus, and converts the touch information into contact coordinates and sends the contact coordinates to the processor 1080, and may receive and execute a command sent by the processor 1080. In addition, the touch panel 1031 may be implemented in a plurality of manners, such as a resistive manner, a capacitive manner, an infrared manner, and a surface acoustic wave. Besides the touch panel 1031, the inputting unit 1030 may further include another inputting device 1032. Specifically, the another inputting device 1032 may include but is not limited to one or more of a physical keyboard, a function key (for example, a volume control key and an on-off key), a trackball, a mouse, and an operating lever.

The displaying unit 1040 may be configured to display information input by the user, information provided to the user, and various menus of the mobile terminal. The displaying unit 1040 may include a display panel 1041; optionally, the display panel 1041 may be configured by using a form of a liquid crystal display (LCD), an organic light-emitting diode (OLED), or the like. Further, the touch panel 1031 may be covered over the display panel 1041; when a touch operation on or near the touch panel 1031 is detected by the touch panel 1031, the touch panel 1031 transfers the touch operation to the processor 1080 to determine a type of a touch event; then, the processor 1080 provides corresponding visual output on the display panel 1041 according to the type of the touch event. Although the touch panel 1031 and the display panel 1041 implement inputting and outputting functions of the mobile terminal as two independent components in FIG. 10, in some embodiments, the touch panel 1031 and the display panel 1041 may be integrated to implement the inputting and outputting functions of the mobile terminal.

The mobile terminal 1000 may further include at least one type of the sensor 1050, for example, a light sensor, a motion sensor, and another sensor. Specifically, the light sensor may include an ambient light sensor and a proximity sensor, where the ambient light sensor may adjust brightness of the display panel 1041 according to lightness of ambient light, and the proximity sensor may close the display panel 1041 and/or backlight when the mobile terminal is moved to an ear. As a type of the motion sensor, an acceleration sensor may detect a size of acceleration in various directions (normally in three axes), and may detect a size and direction of gravity in a static state, which may be used for an application that identifies a position of the mobile terminal (for example, horizontal or vertical orientation switching, a related game, magnetometer position calibration), a function related to vibration identification (for example, a pedometer or knocking), and the like. Other sensors such as a gyroscope, a barometer, a hygrometer, and an infrared sensor may be further configured for the mobile terminal, which is not described repeatedly herein.

The audio circuit 1060, a loudspeaker 1061, and a microphone 1062 may provide an audio interface between the user and the mobile terminal. After converting the received audio data into an electrical signal, the audio circuit 1060 may transmit the electrical signal to the loudspeaker 1061, and then the loudspeaker 1061 converts the electrical signal into a sound signal to output; on the other hand, the microphone 1062 converts a collected sound signal into an electrical signal, which is received and converted by the audio circuit 1060 into audio data; then, the audio data is output to the processor 1080 for processing, and is sent to, for example, another mobile terminal by using the RF circuit 1010, or the audio data is output to the memory 1020 for further processing.

WiFi is a short-distance wireless transmission technology. The mobile terminal may use the WiFi module 1070 to help the user to receive and send an email, browse a webpage, access a streaming media, and the like, which provides wireless broadband Internet access to the user. Although FIG. 10 shows the WiFi module 1070, it may be understood that the WiFi module is not a necessary composition of the mobile terminal 1000, and may be omitted according to demands within a range without changing the essence of the present invention.

The processor 1080 is a control center of the mobile terminal, which connects various parts of the whole mobile terminal by using various interfaces and lines, and executes various functions and data processing of the mobile terminal by running or executing a software program and/or module stored in the memory 1020 and invoking data stored in the memory 1020, so as to perform entire monitoring on the mobile terminal. Optionally, the processor 1080 may include one or more processing units. Preferably, the processor 1080 may integrate an application processor and a modulation and demodulation processor, where the application processor mainly processes an operating system, a user interface, an application program, and the like, and the modulation and demodulation processor mainly processes wireless communication. It may be understood that the modulation and demodulation processor may also not be integrated in the processor 1080.

The mobile terminal 1000 further includes the power supply 1090 (for example, a battery) for supplying power to the various components. Preferably, the power source may be logically connected to the processor 1080 by using a power supply management system, so as to implement functions such as charging management, discharging management, power consumption management by using the power supply management system. Although not shown, the mobile terminal 1000 may further include a camera, a Bluetooth module, and the like, which are not described repeatedly herein.

An embodiment of the present invention further provides a computer storage medium, where the computer storage medium may store a program. When the program runs, a part of or all steps of the method for screen sharing described in the foregoing method embodiments are performed.

It should be noted that, for the purpose of brief description, the foregoing method embodiments are described as a combination of a series of actions; however, persons skilled in the art should understand that the present invention is not limited by the sequence of the described actions because some steps may be performed in other sequences or simultaneously according to the present invention. It should be further understood by persons skilled in the art that the described embodiments all belong to exemplary embodiments, and the involved actions and modules are not necessarily required by the present invention.

In the foregoing embodiments, the embodiments emphasize different aspects, and for the part not described in detail in one embodiment, reference may be made to relevant description of other embodiments.

In the several embodiments provided in the present application, it should be understood that the disclosed apparatus may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The software product is stored in a storage medium and includes several instructions for instructing a computer device (which may be a personal computer, a server, or a network device, or the like) to perform all or a part of the steps of the methods described in the embodiments of the present invention. The foregoing storage medium includes: any medium that can store program code, such as a universal serial bus (USB) flash drive, a read-only memory (ROM), a RAM, a removable hard disk, a magnetic disk, or an optical disc.

The foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, as long as such modifications or replacements do not cause the essence of corresponding technical solutions to depart from the spirit and scope of the technical solutions of the embodiments of the present invention.

What is claimed is:

1. A method for screen sharing, comprising:
initiating, by a first mobile terminal, a screen sharing service;
receiving, by the first mobile terminal by using a wireless local area network, a screen sharing service access request that is corresponding to the screen sharing service and from N second mobile terminal(s), wherein both the first mobile terminal and the N second mobile terminal(s) are located in the wireless local area network, and N is a positive integer;
encoding, by the first mobile terminal, content displayed on a first area in a screen of the first mobile terminal into a first video stream when the N second mobile terminal(s) are allowed to access the screen sharing service; and
sending the first video stream to the N second mobile terminal(s) by using the wireless local area network when the N second mobile terminal(s) are allowed to access the screen sharing service.

2. The method according to claim 1, wherein initiating, by the first mobile terminal, the screen sharing service comprises:
broadcasting, in the wireless local area network by the first mobile terminal, a screen sharing service enabling message that corresponds to the screen sharing service, wherein the screen sharing service access request that corresponds to the screen sharing service is sent by the second mobile terminal after receiving the screen sharing service enabling message; or
receiving, by the first mobile terminal, a screen sharing service enabling query request from the N second mobile terminal(s), and broadcasting, in the wireless local area network, a screen sharing service enabling message that corresponds to the screen sharing service, or sending a screen sharing service enabling message used for responding to the screen sharing service enabling query request to the N second mobile terminal(s), wherein the screen sharing service access request that corresponds to the screen sharing service is sent by the second mobile terminal after receiving the screen sharing service enabling message.

3. The method according to claim 1, further comprising executing, by the first mobile terminal, the first user operation event when a first user operation event from the second mobile terminal is received by using the wireless local area network, wherein the first user operation event is a user operation event for a second area in a screen of the second mobile terminal, and the first video stream received by the second mobile terminal is displayed on the second area.

4. The method according to claim 3, wherein a transparent layer is covered over the first area of the first mobile terminal, wherein the first user operation event is a doodle drawing event, and wherein executing, by the first mobile terminal, the first user operation event when the first user operation event from the second mobile terminal is received by using the wireless local area network comprises displaying, by the first mobile terminal, a doodle drawn by a doodle drawing event on the transparent layer when the doodle drawing event from the second mobile terminal is received by using the wireless local area network.

5. The method according to claim 1, further comprising:
collecting, by the first mobile terminal, a sound signal played by the first mobile terminal, encoding the collected sound signal into a first audio stream, and interleaving the first audio stream into the first video stream; or
decoding, by the first mobile terminal, an audio file to obtain a first audio stream, and interleaving the first audio stream into the first video stream,
wherein the sending the first video stream to the N second mobile terminal(s) by using the wireless local area network comprises sending the first video stream interleaved with the first audio stream to the N second mobile terminal(s) by using the wireless local area network.

6. The method according to claim 1, wherein a bit rate of the first video stream is constant, or a bit rate of the first video stream is corresponding to a value of N, or a bit rate of the first video stream is corresponding to a type of the content displayed on the first area.

7. The method according to claim 1, further comprising:
enabling, by the first mobile terminal, a remote clip service; and
sending, by the first mobile terminal, the clipping object to M second mobile terminal(s) by using the wireless local area network such that the M second mobile terminal(s) update system clipboards of the M second mobile terminal(s) with the clipping object received by the M second mobile terminal(s) when the M second mobile terminal(s) of the N second mobile terminal(s) access the remote clip service by using the wireless local area network and the first mobile terminal monitors that there is an updated clipping object on a system clipboard of the first mobile terminal.

8. The method according to claim 1, wherein the method further comprises:
sending, by the first mobile terminal, a voice-tagging service enabling indication to K1 second mobile terminal(s) of the N second mobile terminal(s) when a document is displayed on the first area in the screen of the first mobile terminal, and when a voice tag that is recorded by a part of or all second mobile terminals of the K1 second mobile terminal(s) after receiving the voice-tagging service enabling indication is received, storing the voice tag and recording an association relationship between the voice tag and a first document, wherein the first document is a document that is displayed by the first mobile terminal on the first area in the screen of the first mobile terminal during duration of recording the voice tag; or
sending, by the first mobile terminal, a voice-tagging service enabling indication to K2 second mobile terminal(s) of the N second mobile terminal(s) when a picture is displayed on the first area in the screen of the first mobile terminal, and when a voice tag that is recorded by a part of or all second mobile terminals of the K2 second mobile terminal(s) after receiving the voice-tagging service enabling indication is received, storing the voice tag and recording an association relationship between the voice tag and a first picture, wherein the first picture is a picture that is displayed by the first mobile terminal on the first area in the screen of the first mobile terminal during duration of recording the voice tag; or
sending, by the first mobile terminal, a voice-tagging service enabling indication to K3 second mobile terminal(s) of the N second mobile terminal(s) when a video is displayed on the first area in the screen of the first mobile terminal, and when a voice tag that is recorded by a part of or all second mobile terminals of the K3 second mobile terminal(s) after receiving the voice-tagging service enabling indication is received, storing the voice tag and recording an association relationship between the voice tag and a first video, wherein the first video is a video that is displayed by the first mobile terminal on the first area in the screen of the first mobile terminal during duration of recording the voice tag.

9. The method according to claim 1, wherein the first mobile terminal is used as a wireless fidelity (WiFi) hotspot, and the N second mobile terminal(s) access the wireless local area network by using the WiFi hotspot; or one second mobile terminal of the N second mobile terminal(s) is used as a WiFi hotspot, and the first mobile terminal and remaining second mobile terminals of the N second mobile terminal(s) except the one second mobile terminal access the wireless local area network by using the WiFi hotspot; or the first mobile terminal is used as a group owner, and the N second mobile terminal(s) are used as group clients and access the wireless local area network in a WiFi Direct mode; or one second mobile terminal of the N second mobile terminal(s) is used as a group owner, and the first mobile terminal and remaining second mobile terminals of the N second mobile terminal(s) except the one second mobile terminal are used as group clients and access the wireless local area network in a WiFi Direct mode; or the first mobile terminal and the N second mobile terminal(s) access the wireless local area network by using a third-party WiFi hotspot.

10. A mobile terminal, comprising:
a service initiating unit configured to initiate a screen sharing service; and
a sharing unit configured to:
receive, by using a wireless local area network, a screen sharing service access request that is corresponding to the screen sharing service and from N second mobile terminal(s), wherein both the mobile terminal and the N second mobile terminal(s) are located in the wireless local area network, and N is a positive integer;
encode content displayed on a first area in a screen of the mobile terminal into a first video stream when the N second mobile terminal(s) are allowed to access the screen sharing service; and
send the first video stream to the N second mobile terminal(s) by using the wireless local area network when the N second mobile terminal(s) are allowed to access the screen sharing service.

11. The mobile terminal according to claim 10, wherein the service initiating unit is specifically configured to:
broadcast, in the wireless local area network, a screen sharing service enabling message that corresponds to the screen sharing service, wherein the screen sharing service access request that corresponds to the screen sharing service is sent by the second mobile terminal after receiving the screen sharing service enabling message; or
receive a screen sharing service enabling query request from the N second mobile terminal(s), and broadcast, in the wireless local area network, a screen sharing service enabling message that corresponds to the screen sharing service, or send a screen sharing service enabling message used for responding to the screen sharing service enabling query request to the N second mobile terminal(s), wherein the screen sharing service access request that corresponds to the screen sharing service is sent by the second mobile terminal after receiving the screen sharing service enabling message.

12. The mobile terminal according to claim 10, further comprising an event response unit configured to execute the first user operation event when a first user operation event from the second mobile terminal is received by using the wireless local area network, wherein the first user operation event is a user operation event for a second area in a screen of the second mobile terminal, and the first video stream received by the second mobile terminal is displayed on the second area.

13. The mobile terminal according to claim 12, wherein a transparent layer is covered over the first area of the event response unit, wherein the first user operation event is a doodle drawing event, and wherein the event response unit is configured to display a doodle drawn by the doodle drawing event on the transparent layer when a doodle drawing event from the second mobile terminal is received by using the wireless local area network.

14. The mobile terminal according to claim 10, further comprising an audio processing unit configured to collect a sound signal played by the mobile terminal and encode the collected sound signal into a first audio stream, or decode an audio file to obtain a first audio stream, wherein the sharing unit is specifically configured to, when the N second mobile terminal(s) access, by using the wireless local area network, the screen sharing service enabled by the mobile terminal, encode the content displayed on the first area in the screen of the mobile terminal into the first video stream, interleave the first audio stream into the first video stream, and send the first video stream interleaved with the first audio stream to the N second mobile terminal(s) by using the wireless local area network.

15. The mobile terminal according to claim 10, further comprising a remote clip service unit configured to enable a remote clip service, and when M second mobile terminal(s) of the N second mobile terminal(s) access the remote clip service by using the wireless local area network, and when monitoring that there is an updated clipping object on a system clipboard of the mobile terminal, send the clipping object to the M second mobile terminal(s) by using the wireless local area network such that the M second mobile terminal(s) update system clipboards of the M second mobile terminal(s) with the clipping object received by the M second mobile terminal(s).

16. The mobile terminal according to claim 10, further comprising a voice tagging unit configured to:
send a voice-tagging service enabling indication to K1 second mobile terminal(s) of the N second mobile terminal(s) when a document is displayed on the first area in the screen of the mobile terminal, and when a voice tag that is recorded by a part of or all second mobile terminals of the K1 second mobile terminal(s) after receiving the voice-tagging service enabling indication is received, store the voice tag and record an association relationship between the voice tag and a first document, wherein the first document is a document that is displayed by the mobile terminal on the first area in the screen of the mobile terminal during duration of recording the voice tag; or
send a voice-tagging service enabling indication to K2 second mobile terminal(s) of the N second mobile terminal(s) when a picture is displayed on the first area in the screen of the mobile terminal, and when a voice tag that is recorded by a part of or all second mobile terminals of the K2 second mobile terminal(s) after receiving the voice-tagging service enabling indication is received, store the voice tag and record an association relationship between the voice tag and a first picture, wherein the first picture is a picture that is displayed by the mobile terminal on the first area in the screen of the mobile terminal during duration of recording the voice tag; or
send a voice-tagging service enabling indication to K3 second mobile terminal(s) of the N second mobile terminal(s) when a video is displayed on the first area in the screen of the mobile terminal, and when a voice tag that is recorded by a part of or all second mobile terminals of the K3 second mobile terminal(s) after receiving the voice-tagging service enabling indication is received, store the voice tag and record an association relationship between the voice tag and a first video, wherein the first video is a video that is displayed by the mobile terminal on the first area in the screen of the mobile terminal during duration of recording the voice tag.

17. A method for screen sharing, comprising:
detecting, by a second mobile terminal, whether a first mobile terminal initiated a screen sharing service;
sending a screen sharing service access request that corresponds to the screen sharing service to the first mobile terminal by using a wireless local area network after detecting that the first mobile terminal initiated the screen sharing service, wherein both the first mobile terminal and the second mobile terminal are located in the wireless local area network;
receiving a first video stream from the first mobile terminal; and
displaying the first video stream on a second area in a screen of the second mobile terminal, wherein the first video stream is obtained by the first mobile terminal by encoding content displayed on a first area in a screen of the first mobile terminal.

18. The method according to claim 17, wherein detecting, by the second mobile terminal, whether the first mobile terminal initiated the screen sharing service comprises:
determining, by the second mobile terminal, that the first mobile terminal enabled the screen sharing service after receiving, by using the wireless local area network, a screen sharing service enabling message that is corresponding to the screen sharing service and from the first mobile terminal; or
broadcasting, by the second mobile terminal, a screen sharing service enabling query request in the wireless local area network, or sending a screen sharing service enabling query request to the first mobile terminal by using the wireless local area network, and when a screen sharing service enabling message that is corresponding to the screen sharing service and from the first mobile terminal is received, determining that the first mobile terminal enabled the screen sharing service.

19. The method according to claim 17, wherein after displaying the first video stream on the second area in the screen of the second mobile terminal, the method further comprises monitoring, by the second mobile terminal, a first user operation event of a user for the second area, and sending the first user operation event to the first mobile terminal by using the wireless local area network when the first user operation event of the user for the second area is detected such that the first mobile terminal executes the first user operation event.

20. The method according to claim 19, wherein a transparent layer is covered over the first area of the first mobile terminal, wherein the first user operation event is a doodle drawing event, and wherein sending the first user operation event to the first mobile terminal by using the wireless local area network when the first user operation event of the user for the second area is detected such that the first mobile terminal executes the first user operation event comprises sending the doodle drawing event to the first mobile terminal by using the wireless local area network when a doodle drawing event of the user for the second area is detected such that the first mobile terminal displays, on the transparent layer, a doodle drawn by the doodle drawing event.

21. The method according to claim 17, wherein the method further comprises:
accessing, by the second mobile terminal, a remote clip service enabled by the first mobile terminal; and
updating, by the second mobile terminal, a system clipboard of the second mobile terminal with a received clipping object when the clipping object from the first mobile terminal is received by using the wireless local area network, wherein the clipping object is a clipping object that is updated on a system clipboard of the first mobile terminal.

22. The method according to claim 17, further comprising:
recording a voice tag and sending the recorded voice tag to the first mobile terminal such that the first mobile terminal stores the voice tag and records an association relationship between the voice tag and a first document when a document is displayed on the second area and a voice-tagging service enabling indication from the first mobile terminal is received, wherein the first document is a document displayed on the second area during duration of recording the voice tag; or
recording a voice tag and sending the recorded voice tag to the first mobile terminal such that the first mobile terminal stores the voice tag and records an association relationship between the voice tag and a first picture when a document is displayed on the second area and a voice-tagging service enabling indication from the first mobile terminal is received, wherein the first picture is a picture displayed on the second area during duration of recording the voice tag; or
recording a voice tag and sending the recorded voice tag to the first mobile terminal such that the first mobile terminal stores the voice tag and records an association relationship between the voice tag and a first video when a video is displayed on the second area and a voice-tagging service enabling indication from the first mobile terminal is received, wherein the first video is a video displayed on the second area during duration of recording the voice tag.

23. A mobile terminal, comprising:
a detecting unit configured to detect whether a first mobile terminal initiated a screen sharing service;
an accessing unit configured to send a screen sharing service access request that corresponds to the screen sharing service to the first mobile terminal by using a wireless local area network after detecting that the first mobile terminal initiated the screen sharing service, wherein both the first mobile terminal and the mobile terminal are located in the wireless local area network; and
a sharing unit configured to receive a first video stream from the first mobile terminal, and display the first video stream on a second area in a screen of the mobile terminal, wherein the first video stream is obtained by the first mobile terminal by encoding content displayed on a first area in a screen of the first mobile terminal.

24. The mobile terminal according to claim 23, wherein the detecting unit is specifically configured to:
determine that the first mobile terminal enabled the screen sharing service after receiving, by using the wireless local area network, a screen sharing service enabling message that is corresponding to the screen sharing service and from the first mobile terminal; or
broadcast a screen sharing service enabling query request in the wireless local area network, or send a screen sharing service enabling query request to the first mobile terminal by using the wireless local area network, and when a screen sharing service enabling message that is corresponding to the screen sharing service and from the first mobile terminal is received, determine that the first mobile terminal enabled the screen sharing service.

25. The mobile terminal according to claim 23, further comprising a monitoring unit configured to monitor a first user operation event of a user for the second area, and to send the first user operation event to the first mobile terminal by using the wireless local area network when the first user operation event of the user for the second area is detected such that the first mobile terminal executes the first user operation event.

26. The mobile terminal according to claim 23, further comprising a remote clip service unit configured to access a remote clip service enabled by the first mobile terminal, and when a clipping object from the first mobile terminal is received by using the wireless local area network, update a system clipboard with the received clipping object, wherein the clipping object is a clipping object that is updated on a system clipboard of the first mobile terminal.

27. The mobile terminal according to claim 23, further comprising a voice tagging unit configured to:
record a voice tag and send the recorded voice tag to the first mobile terminal such that the first mobile terminal stores the voice tag and records an association relationship between the voice tag and a first document when a document is displayed on the second area and a voice-tagging service enabling indication from the first mobile terminal is received, wherein the first document is a document displayed on the second area during duration of recording the voice tag; or
record a voice tag and send the recorded voice tag to the first mobile terminal such that the first mobile terminal stores the voice tag and records an association relationship between the voice tag and a first picture when a picture is displayed on the second area and a voice-tagging service enabling indication from the first mobile terminal is received, wherein the first picture is a picture displayed on the second area during duration of recording the voice tag; or
record a voice tag and send the recorded voice tag to the first mobile terminal such that the first mobile terminal stores the voice tag and records an association relationship between the voice tag and a first video when a video is displayed on the second area and a voice-tagging service enabling indication from the first mobile terminal is received, wherein the first video is a video displayed on the second area during duration of recording the voice tag.
